(19) United States
(12) Patent Application Publication
(10) Pub. No.: US 2008/0033845 A1
(43) Pub. Date: Feb. 7, 2008

(54) Publication Subscription Service Apparatus And Methods

(76) Inventors: Brian McBride, Carp (CA); Laura Mihaela Serghi, Ottawa (CA); Lyle Strub, Ottawa (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(21) Appl. No.: 11/459,136

(22) Filed: Jul. 21, 2006

(51) Int. Cl. G06Q 10/00

(52) U.S. Cl. 705/28

(57) ABSTRACT

Publication subscription service apparatus and methods are disclosed. Restricted forwarding of an electronic publication that is made available to a publication subscription service by a publishing entity may be provided by determining, based on a forwarding restriction established for the electronic publication by the publishing entity, whether the electronic publication is to be forwarded to subscriber systems that are associated with respective subscriptions to the publication subscription service. In a distributed publication subscription service, electronic publication forwarding decisions are independently made at gateway devices or access points that provide access to the service for subscriber systems.

### FIELD OF THE INVENTION

This invention relates generally to communications and, in particular, to publication subscription services provided in communication systems.

### BACKGROUND

Services for which information is distributed through a communication network are generally referred to as network services. “Web services” are an example of network services, and represent the next generation of technology being used for automatically exchanging information between different applications over the public Internet and many private networks. Web services provide a framework for building web-based distributed applications, and can provide efficient and effective automated machine-to-machine communications.

From a technology point of view, web services are network accessible functions that can be accessed using standard Internet protocols such as HyperText Transfer Protocol (HTTP), extensible Markup Language (XML), Simple Object Access Protocol (SOAP), etc., over standard interfaces.

The real power of web services technology is in its simplicity. The core technology only addresses the common language and communication issues and does not directly address the onerous task of application integration. Web services can be viewed as a sophisticated machine-to-machine Remote Procedure Call (RPC) technology for interconnecting multiple heterogeneous untrusted systems. Web services take the best of many new technologies by utilizing XML technology for data conversion/transparency and Internet standards such as HTTP and SMTP for message transport.

There is currently no end-to-end web service/XML network, embedded into a network provider's devices such as edge routers, core routers, and switches. Internet-based solutions for providing XML-based publication subscription or publish/subscribe services, for example, are often implemented in private enterprise networks. Electronic publications are not shared between enterprises or with public networks, and therefore there are limitations to gathering and disseminating publish/subscribe traffic. Since current publish/subscribe dissemination schemes disseminate published documents to all subscribers, publication entities that make documents available to publish/subscribe services may favor such private-network services so as to restrict the distribution of published documents.

Current publish/subscribe systems are also implemented on servers, which can be easily overwhelmed. Server-based implementations may also involve relatively complex and expensive equipment, including XML routers or application server messaging systems.

Thus, there remains a need for improved publication subscription techniques.

### SUMMARY

Some embodiments of the invention support a network-enabled publication subscription service that can perform filtering and aggregation and can scale beyond the capabilities of conventional single-server implementations.

A new set of functions may be added to network elements within a Web services extranet, for example. The new functions may enable the network to perform XML-type content routing in addition to classic network routing/switching, with policy and security necessary for isolation of enterprise systems. WS-notification, for example, may be used between network gateways to give the appearance of a publish/subscribe XML routed network.

According to an aspect of the invention, an apparatus includes a publication module operable to receive an electronic publication made available to a publication subscription service by a publishing entity in a communication system, and a subscriptions management module operatively coupled to the publication module and operable to determine, based on a forwarding restriction established for the electronic publication by the publishing entity, whether the electronic publication is to be forwarded to a subscriber system that is associated with a subscription to the publication subscription service.

The publication module may receive a plurality of electronic publications including the electronic publication and at least one electronic publication for which no forwarding restriction has been established. In this case, the subscriptions management may enable forwarding of the at least one electronic publication to a subscriber system associated with any subscription to the publication subscription service, and determine, based on a forwarding restriction established for each other electronic publication of the plurality of electronic publications, whether each other electronic publication is to be forwarded to a subscriber system that is associated with a subscription.

The communication system may include a private services network accessible by a plurality of subscriber systems including the subscriber system. The subscriptions management module may then be operable to receive the forwarding restriction from at least one of: the publishing entity and a network controller of the private services network. In some embodiments, the subscriptions management module is further operable to receive from the network controller an aggregation of a plurality of forwarding restrictions including the forwarding restriction, and to extract each forwarding restriction of the plurality of forwarding restrictions from the aggregation.

Based on subscription information received from the subscriber system, the subscriptions management module may generate an electronic publication forwarding criterion, and forward the electronic publication to the subscriber system where the electronic publication satisfies the electronic publication forwarding criterion and it is determined based on the forwarding restriction that the electronic publication is to be forwarded to the subscriber system.

The subscriptions management module may include a forwarding criterion check module operable to determine whether the electronic publication satisfies the electronic publication forwarding criterion, and a forwarding restriction check module operatively coupled to the forwarding criterion check module and operable to determine, where the electronic publication satisfies the electronic publication forwarding criterion, whether a subscription associated with the subscriber system satisfies the forwarding restriction.

Where the electronic publication comprises an XML document, and the forwarding criterion may include at least one of: an XPath expression or an XQuery expression.

The apparatus may be implemented, for example, in a gateway device that is operable to provide access to a private services network by the publishing entity.

In some embodiments, the subscriptions management module is operable to determine whether the electronic publication is to be forwarded to a subscriber system by restricting forwarding of the electronic publication to only subscriber systems that are associated with respective subscriptions that satisfy the forwarding restriction.

A private services network may include a plurality of gateway devices, each comprising the apparatus, operable to provide access to the private services network by one or more private services network subscriber systems. The private services network subscriber systems include the publishing entity and the subscriber system. In this case, the subscriptions management module of the gateway device that provides access to the private services network by the publishing entity may be further operable to establish a respective publication subscription service relationship with each other gateway device of the plurality of gateway devices, and the subscriptions management module of each gateway device of the plurality of gateway devices independently determines, based on the forwarding restriction, whether the electronic publication is to be forwarded to a publication subscription service subscriber system, for which the gateway device provides access to the services network, that is associated with a subscription.

A method is also provided, and includes receiving an electronic publication made available to a publication subscription service by a publishing entity in a communication system, determining a forwarding restriction established for the electronic publication by the publishing entity, and determining, based on the determined forwarding restriction, whether the electronic publication is to be forwarded to a subscriber system that is associated with a subscription to the publication subscription service.

The operation of receiving may involve receiving a plurality of electronic publications including the electronic publication and at least one electronic publication for which no forwarding restriction has been established. In this case, the method may also include an operation of forwarding the at least one electronic publication to a subscriber system associated with any subscription to the publication subscription service, and determining whether the electronic publication is be forwarded to a subscriber system may involve determining, based on a forwarding restriction established for each other electronic publication of the plurality of electronic publications, whether each other electronic publication is to be forwarded to a subscriber system that is associated with a subscription.

The method may also include receiving subscription information from the subscriber system, generating, based on the received subscription information, an electronic publication forwarding criterion, and forwarding the electronic publication to the subscriber system where the electronic publication satisfies the electronic publication forwarding criterion and it is determined based on the forwarding restriction that the electronic publication is to be forwarded to the subscriber system.

In some embodiments, the method also includes establishing a publication subscription service relationship between gateway devices that provide access to a private services network by one or more private services network subscriber systems, the private services network subscriber systems comprising the publishing entity and the subscriber system, and forwarding the electronic publication from a gateway device that provides access to the private services network by the publishing entity to each other gateway device of the plurality of gateway devices. Each gateway device of the plurality of gateway devices independently determines the forwarding restriction and determines whether the electronic publication is to be forwarded to a publication subscription service subscriber system, for which the gateway device provides access to the private services network, that is associated with a subscription.

The method may be embodied in instructions stored on a machine-readable medium.

In accordance with a further embodiment of the invention, a communication system includes a first gateway device and a second gateway device. The first gateway device includes a publication module operable to receive an electronic publication made available to a publication subscription service of the communication system, and a subscriptions management module operatively coupled to the publication module and operable to provide access to the publication subscription service by at least one subscriber system of the communication system, to determine whether the electronic publication is to be forwarded to a subscriber system of the at least one subscriber system, and to forward the electronic publication to at least one other gateway device. The second gateway device includes a second publication module operable to receive the electronic publication from the first gateway device, and a second subscriptions management module operatively coupled to the second publication module and operable to provide access to the publication subscription service by at least one further subscriber system of the communication system, and to determine, independently of a determination made by the subscriptions management module of the first gateway device, whether the electronic publication is to be forwarded to a subscriber system of the at least one further subscriber system.

The system may be implemented in a private services network, with the first and second gateway devices providing access to the private services network by respective groups of one or more private services network subscriber systems. The private services network subscriber systems include a publishing entity by which the electronic publication is made available and at least one subscriber system associated with a respective subscription to the publication subscription service. The subscriptions management module of the one of the first and second gateway devices that provides access to the private services network by the publishing entity may be further operable to establish a publication subscription service relationship the other of the first and second gateway devices.

The first and second gateway devices may include gateways of at least one of the following types: a client gateway for providing access to the private services network through a secure access connection or network, a public network gateway for providing access to the private services network through a public network, a mobile gateway for providing access to the private services network by a mobile subscriber system, and a services network gateway for providing access to the private services network through another private services network.

Another aspect of the invention relates to a method that includes receiving an electronic publication made available to a publication subscription service of a communication system, determining, at an access point of a plurality of access points through which respective groups of communication system subscriber systems access the communication system, whether the electronic publication is to be forwarded to a subscriber system of the group of subscriber systems that access the communication system through the access point, forwarding the electronic publication to a further access point of the plurality of access points, and determining at the further access point, independently of a determination made at the access point, whether the electronic publication is to be forwarded to a subscriber system of the group of subscriber systems that access the communication system through the further access point.

A machine-readable medium according to a further aspect of the invention stores a data structure that includes an identifier of an electronic publication made available by a publishing entity in a communication system to a publication subscription service, and an indication of a forwarding restriction, established for the electronic publication by the publishing entity, based upon which a determination is to be made as to whether the electronic publication is to be forwarded to a subscriber system associated with a subscription to the publication subscription service.

The data structure may also include an identifier of a subscriber system that is associated with a subscription to the publication subscription service, and an indication of a forwarding criterion, the forwarding criterion defining a criterion to be satisfied by electronic publications that are to be forwarded to the subscriber system.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a communication system client gateway.

FIG. 3 is a block diagram of a communication system public network gateway.

FIG. 4 is a block diagram of a communication system services network gateway.

FIG. 5 is a block diagram of a network controller.

FIG. 6 is a block diagram of a publication subscription service apparatus.

FIG. 7 is a block diagram of a publication subscription service method.

FIGS. 8A and 8B are block diagrams of publication and subscriber system data structures.

### DETAILED DESCRIPTION OF PREFERRED EMBODIMENTS

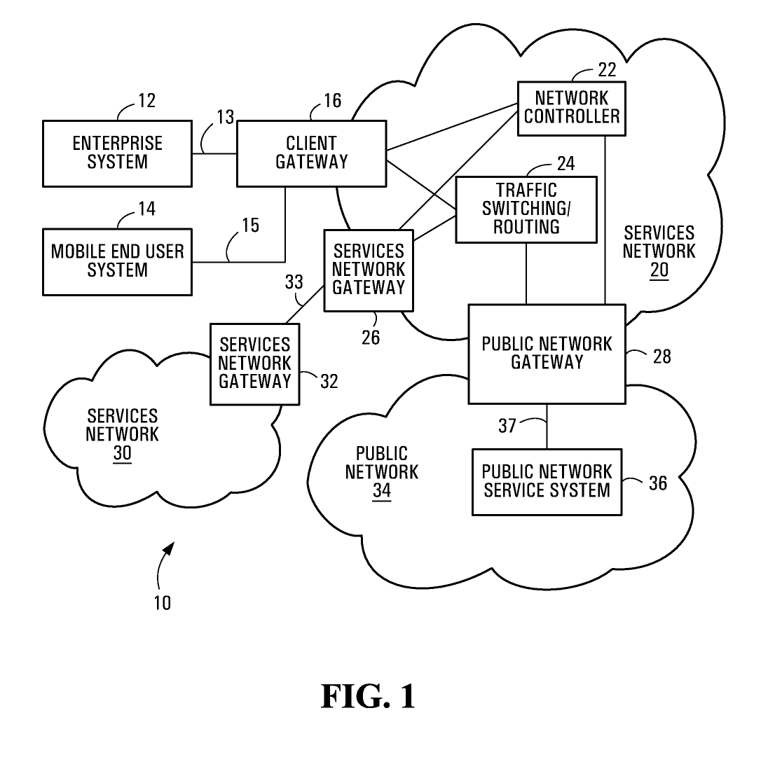

FIG. 1 is a block diagram of a communication system incorporating an embodiment of the invention. The communication system 10 includes an enterprise system 12, a mobile end user system 14, a client gateway 16, a services network 20 that includes a network controller 22 and traffic switching and/or routing components generally designated 24, services network gateways 26, 32, a services network 30, a public network gateway 28, and a public network 34 that includes a public network service system 36.

Although many enterprise systems 12 and/or end user systems such as the mobile end user system 14 can be connected to a client gateway 16, and also, many client gateways 16, services network gateways 26, and public network gateways 28 may reside at the border of the services network 20, only one example of each of these components has been shown in FIG. 1 to avoid overly complicating the drawing. It should therefore be appreciated that the system of FIG. 1, as well as the contents of the other drawings, are intended solely for illustrative purposes, and that the present invention is in no way limited to the particular example embodiments explicitly shown in the drawings and described herein. Embodiments of the invention may be implemented in communication systems that have further or fewer components than shown, such as communication systems that do not include all of the gateway types shown in FIG. 1, for example.

The enterprise system 12 represents a private network which may provide, use, or both provide and use, network services that are offered and managed throughout the services network 20. In a typical installation, an enterprise system includes such components as a firewall to provide external access control and filter external traffic entering the enterprise, traffic switching and routing equipment, one or more servers for supporting network services, and user terminals, illustratively personal computers. A corporate private network is one example of an enterprise system 12.

The mobile end user system 14 is illustrative of a services network client or subscriber system that is not part of a specific enterprise system. End user systems may be mobile, as shown, or fixed. The mobile end user system 14 may be connected to the client gateway 16 through a web services mobile gateway, for example. A mobile end user system 14, as well as fixed end user systems, may instead be physically connected to a client gateway 16. A portable computer system is mobile in the sense that it may connect to a client gateway through different locations and physical connections in an access network.

Those skilled in the art will be familiar with many different types of enterprise systems and end user systems that provide and/or use network services. Embodiments of the present invention relate primarily to managing a particular type of service, specifically a publication subscription or “publish/subscribe” service, as opposed to how these services are actually supported in the enterprise system 12 or used in end user systems such as the mobile end user system 14, and accordingly the enterprise system 12, the mobile end user system 14, and their operation are described only briefly herein to the extent necessary to appreciate aspects of the invention. Enterprise systems and mobile end user systems are illustrative types of communication system subscriber systems, which may also subscribe to a publication subscription service.

A virtual extranet service portal, which may be implemented as a software application for instance, in the enterprise system 12 and the mobile end user system 14, may be deployed to allow network service providers and consumers to interact with the services network 20. A service portal might allow users to log into the services network 20 and authenticate themselves with the services network by means of federated identity or another authentication scheme, and may also enable other additional capabilities such as displaying various services lists, descriptions, etc., without substantially affecting how an end user provides and/or consumes network services.

The connections 13, 15 may be direct connections as shown in FIG. 1, or indirect connections that traverse intermediate components and possibly other communication networks generally referred to herein as access networks. However, the present invention is not restricted to network connections, or any other particular type of connection, between the enterprise system 12, the mobile end user system 14, and the client gateway 16. The connections 13, 15 may thus include any of direct, indirect, wired, and wireless connections.

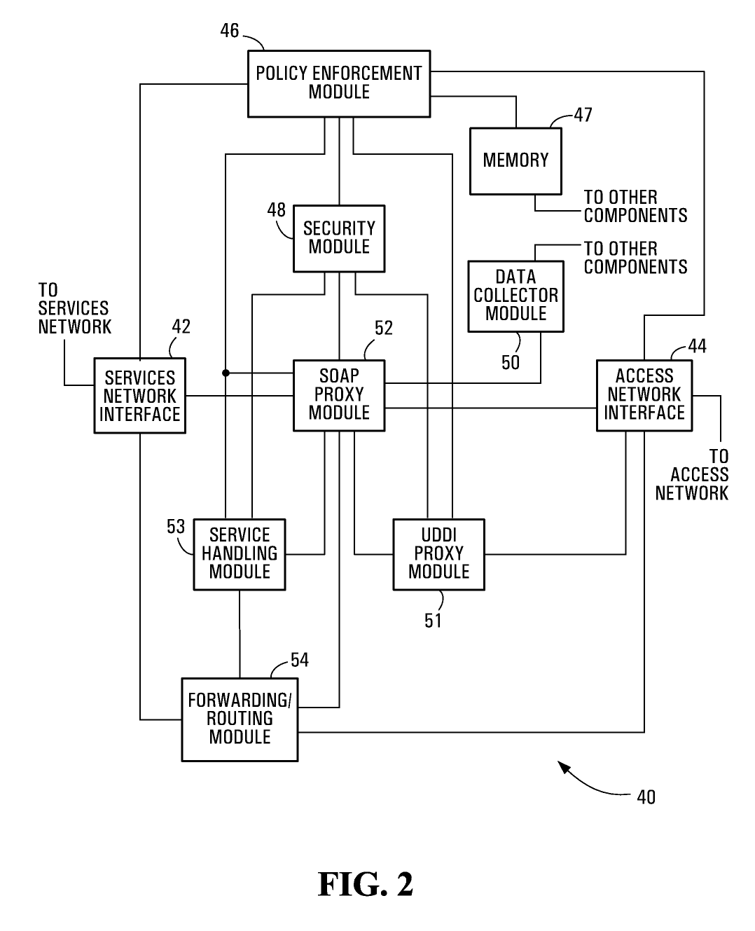

Access to the services network 20 is provided for the enterprise system 12 and the mobile end user system 14 by the client gateway 16. The client gateway 16 is an edge device into the services network provider infrastructure, and represents a gateway into the virtual extranet service provided by the services network 20. The client gateway 16 is in essence a secure network service proxy appliance for implementing a web service gateway function, supporting proxies for network services and Web services XML “standards”, for example, as well as new features. According to one embodiment, the client gateway 16 is a high-performance device implemented at least in part using hardware, and is configured for operation with embedded software for deployment by a services network provider. An illustrative example of a client gateway 16 is described in detail below with reference to FIG. 2.

It will be apparent from the foregoing that several types of service provider may be involved in the system 10. Network services are provided, for example, by the enterprise system 12. The services networks 20, 30 are provided by other, different service providers. A network service provider, such as the enterprise system 12 in this example, thus offers network services, and providers of the services networks 20, 30 provide, to network service providers, another service that implements a network of services within which network service providers may make network services available for use by network service consumers that are outside their own private systems.

A provider of a network service is referred to herein as a network service provider, and a provider of a services network is referred to primarily as a services network provider. Thus, a network service provider provides one or more network services, and a services network provider allows these network services to be offered externally, illustratively in a virtual extranet. The services network provider might also own or operate the underlying communication network on which the services network is built, although this need not necessarily be the case in all embodiments of the invention.

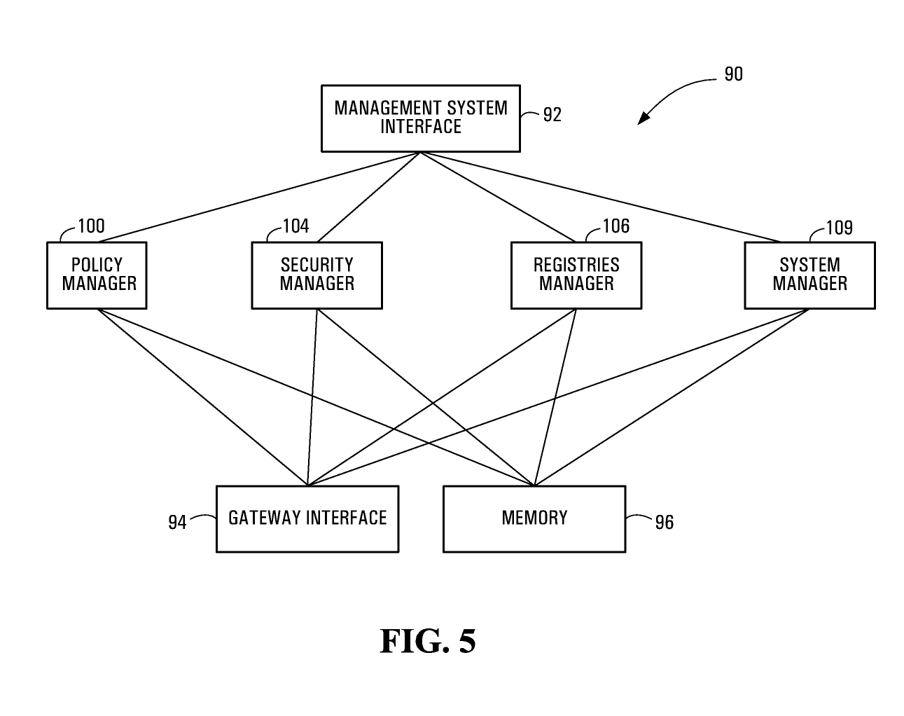

The network controller 22 provides control plane functionality of a service manager, and may be implemented as a network scale device, illustratively as a dedicated card for edge routers or a dedicated XML appliance, to be deployed by an operator of a communication network. It may be used, for example, for managing a virtual extranet service, for hosting a central repository for all services offered within the virtual extranet, policies, service level agreements (SLAs), and other network monitoring data, and to secure, manage, provision, and store policies for end-to-end network services applications. The network controller 22 is described in further detail below by way of illustrative example with reference to FIG. 5.

Data traffic traverses the services network 20 through switching and/or routing equipment, which is designated generally at 24. Whereas control/management traffic is handled by the network controller 22, actual communication traffic is processed by the gateways 16, 26, 28, and by the switching/routing components 24.

The services networks 20, 30 may be implemented as virtual extranet architectures. Although details of the services network 30 have not been explicitly shown in FIG. 1, it should be appreciated that the services network 30 may be substantially similar in structure and operation to the services network 20.

In one embodiment, the services network 20 represents a virtual network built over a basic network infrastructure and an application-level overlay network over the virtual network, as a sort of private-managed services network which uses, for example, Internet technology and underlying Layer 1, 2, 3, and 4 technologies to securely share part of an enterprise's information or operations with other enterprises, such as suppliers, vendors, partners, customers, or other businesses for instance. The virtual network of a services network in this case represents a virtual network fabric that may be implemented using Layer 1 or 2 forwarding, IP routing and/or application level routing. A virtual extranet network may provide connectivity and mechanisms for synchronous communications, such as REQUEST/RESPONSE schemes, and also asynchronous communications.

An application-level overlay in a virtual network may be implemented using application level routers, which communicate with each other and end clients at the application layer, but using underlying normal networking facilities. Although an application-level overlay may provide connectivity and asynchronous content delivery based on subscribers' interests, embodiments of the invention allow content-based routing functionality that is normally supported by application-level routers such as XML routers without requiring such routers to be implemented in a communication system.

Those skilled in the art to which the present invention pertains will be familiar with many different types of communication networks on which a separate logical routing plane may be overlaid. The present invention is not in any way limited to implementation in conjunction with a services network having any particular type of underlying communication network.

The services network gateways 26, 32 represent network devices that may be used to link two extranet services, the services networks 20, 30, which are offered by different network providers. Each extranet service may be implemented in the core network of a different network provider, and therefore in different administrative domains. The services network gateways 26, 32 allow network services data traffic from one services network to be forwarded into the other services network and also permits control traffic exchange. Each of the services network gateways 26, 32 implements a gateway-to-gateway exchange function and provides a secure channel of communication with the other services network gateway. The services network gateways 26, 32 thereby provide a mechanism for network services traffic to cross multiple network providers' networks.

Although FIG. 1 shows respective border gateways 26, 32 in each services network 20, 30 and a connection 33 therebetween, a single services network gateway may span both services networks in some embodiments, as shown for the public network gateway 28.

One purpose of the services network gateways 26, 32 might be to support interworking between network services of the services network 20 and the services network 30 while providing means for service logging, transaction auditing, customized service publishing, endpoint accounting, service administration, access policy enforcement, content integrity and confidentiality, and customer application protection. The services network gateways 26, 32 may thus be considered service mediation and delivery points for both services networks 20, 30. The services networks 26, 32 may provide secure access to network services hosted in the services networks 20, 30 by network service consumer clients of either of the services networks 20, 30, illustratively by publishing network services provided by clients in each services network in services registries of the other services network, in accordance with service and managerial policies.

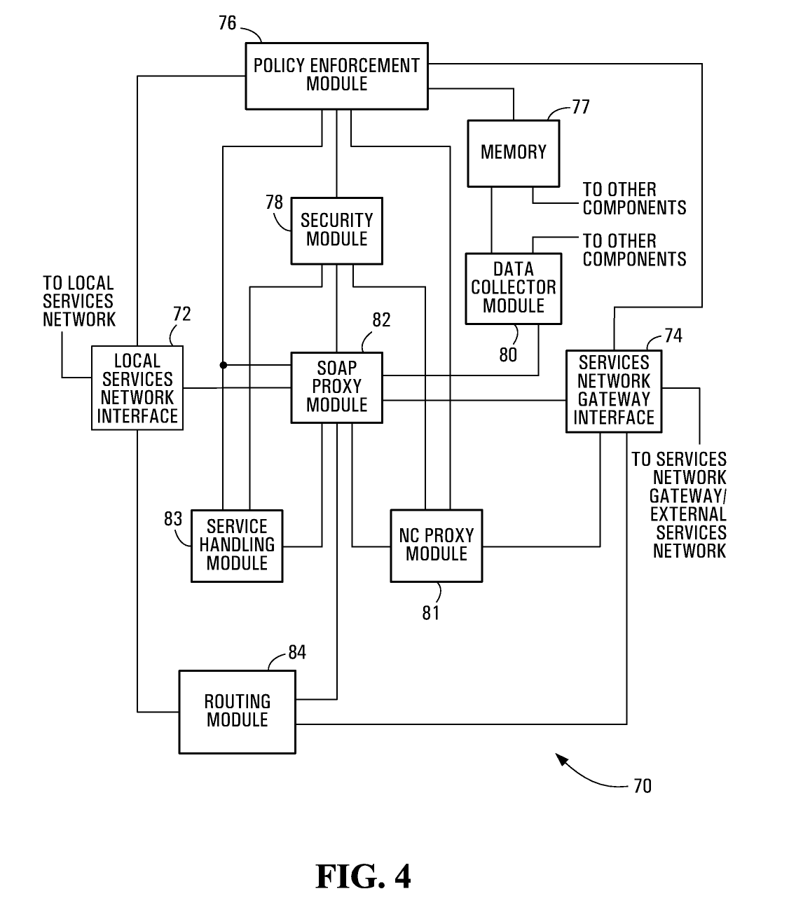

Like the client gateway 16, the services network gateways 26, 32 may be secure network service proxy appliances providing web service gateway functions, and may be implemented as high-performance hardware-based edge devices for deployment by services network providers. The services network gateways 26, 32 are described by way of illustrative example below with reference to FIG. 4.

The connection 33 may include any of direct, indirect, wired, and wireless connections, and is preferably a secure tunnel where the services network 20 includes subscriber systems from different private networks or organizations. Many examples of tunnelling techniques, as well as and other mechanisms for providing secure communications, will be apparent to those skilled in the art.

The public network gateway 28 is another type of gateway device in the system 10, and may support similar interworking functions as the services network gateways 26, 32, but between the services network 20 and the public network 34. In addition to bridging the services network 20 and the public network 34, the public network gateway 28 may also support other functions, such as service logging, transaction auditing, customized service publishing, brokering of identity, endpoint authentication, endpoint authorization, endpoint accounting, service administration, access policy enforcement, content integrity and confidentiality, and customer application protection.

Public network services hosted in the public network 34 by the public network service system 36, for example, can be made available to subscribers of the services network 20, illustratively by publishing the public network services in services registries of the services network 20, in accordance with service and managerial policies. Access to network services hosted by subscriber systems of the services network 20 for subscriber systems connecting to the services network through the public network 34, again in accordance with service policies, may also be provided by the public network gateway 28 in a manner similar to that provided by the client gateway 16 to its connected subscriber systems.

The public network connection 37 between the public network gateway 28 and the public network service system 36 may include any of direct, indirect, wired, and wireless connections, depending upon the type of the public network 34. One well known example of a public network is the Internet, in which the public network service system 36 would typically be connected to the public network gateway indirectly, through public network provider and public network core communication equipment. The present invention is not restricted to any specific type of public network or connection, many examples of which will be apparent to those skilled in the art.

A public network service system such as 36 is a public counterpart of the private enterprise system 12, and represents a network or system which may provide, use, or both provide and use, network services. Thus, the public network service system 36 may be substantially similar in structure to the enterprise system 12. Whereas the enterprise system 12 would normally restrict access to its private network services to partners of the enterprise, however, network services provided by the public network service system 36 would usually be made more easily and widely accessible. As described above for the enterprise system 12, those skilled in the art will be familiar with many different types of systems that provide and/or use network services, and accordingly the public network service system 36 is described only briefly herein.

The public network gateway 28 may also provide enterprise systems with the specific, encompassing, and reliable protection. Protection may be provided, for example, at an enterprise system's domain boundary against malformed messages and malicious content, during traffic transfer by means of encryption (Secure Sockets Layer (SSL) at transport level, XML Encryption and XML Digital Signature at field level for instance), and for Authentication, Authorization, and Audit (user, group, role, content-based access control).

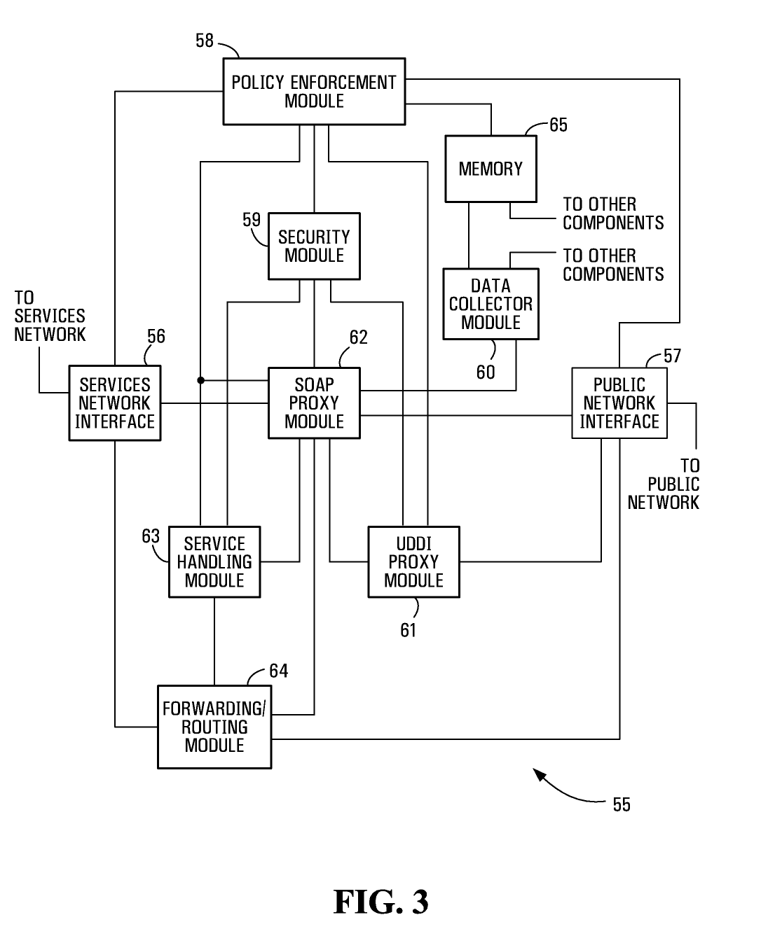

As noted above for the client gateway 16 and the services network gateways 26, 32, the public network gateway 28 may be a secure network service proxy appliance providing a web service gateway function, and may be implemented as a high-performance hardware-based edge device. The public network gateway 28 is described by way of illustrative example below with reference to FIG. 3.

In operation, the services network 20 and the gateways 16, 26/32, 28 enable network services provided by the enterprise system 12 or other network service providers in the services networks 20, 30 or the public network 34 to be made accessible to subscriber systems connected to the services networks or the public network in a managed and secure manner and with a flexible application program interface. These subscriber systems may include user systems in the enterprise system 12, other enterprise systems, or end user systems such as the mobile end user system 14 connected to the services network 20 through a gateway device, which may be a client gateway, a services network gateway, or a public network gateway. The service implemented by the services network 20 is supported by the gateways 16, 26/32, 28, which support communication protocols, and the network controller 22, which supports network, service, and services network subscriber management functions.

The framework of the services network 20 may be divided into three areas, including communication protocols, service description, and service discovery. In one embodiment, the service network 20 uses existing standards and specifications that have been developed for each of these areas.

For example, in the area of communication protocols, SOAP is one standard protocol that may be used to transport web services messages between a web client and a web server application, two service endpoints identified by respective Uniform Resource Identifiers (URIs). SOAP is an extensible protocol that may provide for the transfer of additional information. For example, it is widely used to provide for transfer of additional information relating to content security mechanisms being used.

Web Services Description Language (WSDL) is an XML dictionary for describing a web service, its functionality, specifications, inputs, outputs, and accessible methods. It is a standardized approach to network service description.

These web services protocols (SOAP and WSDL) provide the capabilities and messaging facilities to bind and execute functionality anywhere, on any platform, without the need for custom code.

One well known service discovery mechanism is Universal Description, Discovery, and Integration (UDDI). UDDI defines a standard mechanism for publishing and finding web services, and specifies how registries match WSDL-described service requirements with providers of those services. UDDI enables enterprises and applications to find web services over a services network or the Internet and allows operational registries to be maintained. UDDI can be used to list web services from different providers, and gives their provider descriptions, locations, services descriptions, associated access lists, and security levels.

Other web services standards that are referenced herein and may be used in implementing embodiments of the invention include standards relating to addressing (WS-Addressing), reliable messaging (WS-Reliability), policy (WS-Policy), notification (WS-Notification) and identity scope management (WS-Trust and WS-Federation).

Although the above specifications and standards are well known, the use of these standards in accordance with embodiments of the invention is not known.

As described briefly above, the client gateway 16 is a service delivery point for direct clients of the service, illustratively a private extranet service, provided by the services network 20. The client gateway 16 also provides secure access to the services network 20, protecting both a provider of a service and a client of the service, such as the enterprise system 12 and the mobile end user system 14.

In many embodiments, communications through the client gateway 16 and the services network 20 is secure. Standards-based security techniques such as Transport Layer Security (TLS), SSL, WS-Security, XML-Encryption, and XML-Signature may be used to provide secure communications while leveraging existent enterprise ingress and egress certificates that would normally already have been established for the enterprise system 12. These standards-based techniques, as well as other techniques that may be or become apparent to those skilled in the art, ensure that authorized service consumers can participate in the services network 20.

The client gateway 16 may also classify and split incoming communication traffic data into control traffic to be forwarded to the network controller 22 and communication traffic to be forwarded towards a destination through the components 24 and possibly through another client gateway, the services network gateway 26, or the public network gateway 28.

In general, a potential consumer of a network service such as a web service application can only make use of a network service that is known to exist and has a valid service description. It is thus desirable for a network service provider to communicate the existence of a network service to potential consumers. This may be accomplished by publishing network services to registries, for instance. In the system 10 of FIG. 1, the client gateway 16 may allow the enterprise system 12 to publish its internal network services to the services network 20. The client gateway 16 may also or instead allow the enterprise system 12 and/or the mobile end user system 14 to consume network services provided by other subscriber systems of the services network 20.

As disclosed in further detail herein, the extent to which the services provided by an enterprise system 12 are made available to other members of the services network 20 may be controlled by the client gateway 16 and the network controller 22.

Network service providers may publish internal network services to the services network 20 for use by other members of the services network 20. In many implementations, the services network 20 and the enterprise system 12 are expected to be secure private networks, and communications on the connections 13, 15 are also secure. This may be accomplished using secure tunnelling techniques, examples of which will be readily apparent to those skilled in the art. Secure communications at both access and network sides of the client gateway 16 provide a level of assurance that private network services available to members of the services network 20 are provided only by members of the services network and can only be consumed by members of the services network who are authorized to consume them according to the service access policy provided by the service provider along with the service description.

Since communications with the services network 20 by network service providers and consumers traverse the client gateway 16, the client gateway may also capture comprehensive audit records that may be used locally and/or by the network controller 22 to maintain regulatory and policy compliance, for example. Audit records may also or instead be used by other components or systems, such as a billing system with microbilling capabilities for according service charges to consumers.

The network controller 22 provides central control plane functions for the services network 20, and thus implements the functionality of a network services manager and a services network subscriber manager. One main responsibility of the network controller 22 might be maintaining a network services global repository. The network controller 22 may store non-volatile subscriber and service profiles for use in establishing run-time client contexts, for example.

Like the gateways 16, 26/32, 28, the network controller 22 may be implemented as a high-performance hardware-based device with standards-based software for deployment by a services network provider. It may be used for managing the services network 20, to communicate to the client gateway 16, the services network gateway 26, and the public network gateway 28 run-time service and client management and provisioning information regarding the distribution of service descriptions to clients and the enforcement of policies for end-to-end network services, and also to display and manage the list of available network services. While the network controller 22 is the services network management entity, the client gateway 16, the services network gateway 26, and the public network gateway 28 may actually enforce policies and security rules on traffic. Traffic traverses a provider's core network, as represented at 24 in FIG. 1, through the gateways 16, 26, 28, and the network controller 22 processes control and management traffic.

The network controller 22 may implement at least a subset of core functions, including network services storage and management of information such as location, ownership, access level groups, service lists, and other basic characteristics of network services, central policy repository and rights management, security specifications, SLA requirements such as hard Quality of Service (QoS) requirements suitable for end business to end business transactions for instance, and additional repositories for such information as subscriber system profiles, transaction auditing services, logs, etc. It may also maintain subscriber system profiles for use by run-time functions such as the federation of identity and brokering of trust with other services networks such as the services network 30.

To be able to offer end-to-end transaction security, reliability of message transport, and identity management, network service providers and services network providers would normally meet on middle ground to offer one set of combined management functions. The network controller 22, in conjunction with the gateways 16, 26, 28, may take the burden off the enterprise system 12 and other network provider systems by replacing a provider system's private management methods and tools with standards-based proxy modules offering the same functions at the edge of the services network 20.

The network controller 22 may also allow some security functions to be delegated to an extranet service, thereby freeing the local enterprise applications from providing certain security aspects such as an identity provider service, an XML digital signature validation service, XML schema integrity, etc. By using a virtual extranet service, application integration within and between enterprises becomes easier and more efficient, end consumer business applications become more visible, and the costs and complexity associated with addition of partners to an enterprise system are reduced.

The network controller 22 may use subscriber system profiles to determine the network services that should be made available to each subscriber system. The network controller 22 cooperates with the gateways 16, 26, 28 to make available to each subscriber system that accesses the services network 20 through those gateways a customized subset of network services, from the set of all services available within the services network 20, that a subscriber system is authorized to access.

The services network 30 may be substantially similar to the services network 20, providing an extranet service through which its subscriber systems, through client gateways and a network controller (not shown), can make network services available to other subscriber systems and/or use network services provided by the other subscriber systems. Through its services network gateway 32 and the services network gateway 26, the services network 30 may exchange network service control traffic and communication traffic with the services network 20.

Operation of the gateways 16, 26/32, 28 and the network controller 22 are described in further detail below with reference to FIGS. 2 through 5.

Considering first the client gateway 16, FIG. 2 is a block diagram of an example client gateway. The example client gateway 40 includes a services network interface 42, an access network interface 44, a policy enforcement module 46 operatively coupled to the interfaces and to a memory 47, a security module 48 operatively coupled to the policy enforcement module, a SOAP proxy module 52 operatively coupled to the interfaces, to the policy enforcement module, and to the security module, a data collector module 50 operatively coupled to the SOAP proxy module and to the memory, a UDDI proxy module 51 operatively coupled to the policy enforcement module, to the security module, to the SOAP proxy module, and to the access network interface 44, a service handling module 53 operatively coupled to the policy enforcement module, to the security module, and to the SOAP proxy module, and a forwarding/routing module 54 operatively coupled to the services handling module and to the interfaces. Although not explicitly shown in FIG. 2 to avoid overly complicating the drawing, it should be appreciated that any or all of the other components of the client gateway 40 may be operatively coupled to the memory 47 and/or to the data collector module 50.

The access network interface 44 represents a remote access point through which the client gateway 40 connects to an enterprise system or other type of subscriber system. However, subscriber systems need not necessarily communicate with client gateways through network connections. It should therefore be understood that the interface 44 provides an interface to a member of a services network through an access connection, which may or may not strictly be a network connection.

The structure and operation of the access network interface 44 will be dependent upon the type of connection over which the client gateway 40 communicates with its subscriber system(s). In general, an access network interface 44 would include physical components that exchange communication signals with a communication medium, and hardware-, firmware-, and/or software-implemented components that generate and process the communication signals. Various implementations of such an interface will be apparent to those skilled in the art. A client gateway may in some embodiments include multiple access interfaces, possibly of different types. The client gateway 16 (FIG. 1), for example, may include a wired medium interface for communicating with the enterprise system 12 and a wireless network interface for communicating with the mobile end user system 14 through a mobile communication network.

According to one embodiment, the access network interface 44 performs security tunnel termination for subscriber systems attempting to connect into a services network. Virtual Local Area Network (VLAN), Point-to-Point Protocol (PPP), Multi-Protocol Label Switching (MPLS), and IP Security (IPSec) are all examples of protocols that may be used by the access network interface 44 to communicate with a subscriber system. Other protocols and communication schemes may be or become apparent to those skilled in the art.

The memory 47 may include one or more memory devices, such as solid state memory devices, for storing information. Other types of memory devices, including memory devices for use with movable and/or removable storage media, and multiple memory devices of different types, may also be provided as the memory 47. The type of memory device or devices implemented as the memory 47 in the client gateway 40 is a matter of design, and may be dependent upon the particular type of equipment in which the client gateway is implemented. A circuit card for communication equipment, for example, would normally incorporate volatile and non-volatile solid state memory devices as the memory 47.

It will become apparent as the present description proceeds that the information stored in the memory 47 may be used by the other components of the client gateway 40 in performing their respective functions. Any or all of the components 46, 48, 50, 51, 52, 53, 54 may access information stored in the memory 47. Similarly, although no connection between the memory 47 and the interfaces 42, 44 has been shown in FIG. 2 to avoid congestion, these interfaces or internal components thereof may also interact with the memory 47.

Any or all of the components 42, 44, 46, 48, 50, 51, 52, 53, 54 may be implemented at least partially as software, which might also be stored in the memory 47.

The form of the internal connections between components of FIG. 2 may also be dependent to some extent upon the particular type of device or equipment in which the client gateway 40 is implemented. Internal bus structures, for example, are often used in electronic devices, although other types of connections may be used in addition to or instead of an internal bus. It should also be appreciated that interconnections need not necessarily be via a physical medium, as in the case of software-based implementations for instance.

Functional components that implement services network functions of the client gateway 40 have been shown in somewhat more detail than access-side functions in FIG. 2, as embodiments of the invention relate primarily to functions that are performed on the services network side of the access network interface 44. For example, whereas the access network interface 44 provides security functions for access connections, a security module 48, which provides network-side security functions, has been shown separately from the services network interface 42 in FIG. 2. Other network-side functional components have similarly been shown separately in FIG. 2 for illustrative purposes.

This representation of separate functional components in the client gateway 40 is not intended to limit the present invention. The network-side functions a client gateway may be implemented using further or fewer components than explicitly shown in FIG. 2, possibly with different interconnections. For example, functions of the policy enforcement module 46 could be incorporated into each component that applies policies. Security policies could be both managed and applied by the security module 48 for instance.

In software-based embodiments, functions may be implemented in respective software modules or combined into fewer software modules for execution by a single hardware component, illustratively a processing element such as a microprocessor, an Application Specific Integrated Circuit (ASIC), a Programmable Logic Device (PLD), a Field Programmable Gate Array (FPGA), a Digital Signal Processor (DSP), a microcontroller, or some other type of intelligent integrated circuit. Software might instead be executed by multiple hardware components, a microprocessor and a DSP or a network processor plus several ASICs and FPGAs for instance. Combined implementations in which some functions are implemented in software and others are implemented in hardware or firmware, which tend to operate faster than software, are also contemplated.

Accordingly, functions may be divided or integrated in a different manner than shown in FIG. 2, and any of the functional modules described herein may be implemented in software, hardware, firmware, or some combination thereof.

Given the various possible implementations of the components shown in FIG. 2, these components are described herein primarily in terms of their functions. Based on the functional descriptions, a person skilled in the art would be enabled to implement embodiments of the invention in any of various ways.

The policy enforcement module 46 implements services network policy enforcement for network services as configured by services network subscriber systems in their profiles and advertised in their services' descriptions to a network controller.

Policy assertions that specify traditional requirements and capabilities that will ultimately manifest on the wire, such as an authentication scheme required for a specific customer and/or transport protocol selection for instance, will affect a client gateway. Therefore, these policies assertions are downloaded from a network controller into client gateways in some embodiments and enforced by the policy enforcement module 46.

Authentication and authorization of network service providers and consumers, administration and verification of transactions involving network services, and ensuring privacy and integrity of communication traffic associated with network services are examples of functions that may be involved in enforcing policies by the policy enforcement module 46 in conjunction with other components. The policy enforcement module 46 may interact with the security module 48, for example, for authentication such as by verifying a message digital signature. Thus, enforcement of security policies may involve both the policy enforcement module 46, which manages the policies, and the security module 48, which actually applies the policies by authenticating clients and possibly passing or dropping communication traffic, for example.

It should therefore be appreciated that the policy enforcement module 46 need not itself actually apply the policies it manages for enforcement. Interaction between the policy enforcement module 46 and other components to apply policies to services network clients and transactions will become apparent as the present description proceeds.

Through the policy enforcement module 46 at the client gateway 40, client authentication with a services network or a virtual extranet service may be provided. Current enterprise-centric network services require client authentication with each specific network service. A network service consumer with which the access network interface 44 communicates is a client of the client gateway 40, and gains access to network services across a services network through a single sign-on with the client gateway. The client gateway 40 thus removes the per-service authentication burden from its clients. Information to be used in client authentication is an example of one type of information that may be stored in the memory 47, preferably in a secure memory device or area.

For the case when a client XML digital signature is not present, the policy enforcement module 46 may cooperate with the security module 48 to generate a security assertion in accordance with what the end network service expects in terms of security assertions. The new security assertion is attached to service messages to assert the identity of the client and the integrity of the message.

When the client's identity preference is present but is different from the network service's preference, the policy enforcement module 46 may cooperate with the security module 48 to map a specific digital certificate, illustratively an X.509 certificate, into a different security assertion, such as a Security Assertion Markup Language (SAML) assertion.

Well known mechanisms drawn from standards such as SAML, WS-Federation, and WS-Trust could be used for these functions.

In one embodiment, the policy enforcement module 46 offers hardware implementation of federated identity, access control, and enforcement of policies that have been set up in advance using the network controller 22 (FIG. 1). Federated identity allows users to create and authenticate a user identity and then share the identity between domains and service providers without centrally storing personal information.

SLAs, tailored for web services operations, may also be in place for either or both of access-side and network-side communication links through which the client gateway 40 communicates with its clients and a services network. The policy enforcement module 46 may also monitor communication traffic levels to enforce SLA-related parameters, which may be stored in the memory 47.

As described briefly above, the virtual extranet services network according to an embodiment of the invention is XML-standard based, and thus the policy enforcement module 46, in conjunction with the service handling module 53 described below, may also enforce XML message header and message payload transformations for ingress data traffic received from clients of the client gateway 40 through on the access network interface 44. Transformations may also be made from other message formats into XML-standard based network service messages. Inverse transformations, as well as transformations between non-XML formats used in access networks and services networks, are also contemplated.

The security module 48 implements security standards to guarantee the security of communications over the services network. In some embodiments, the security module 48 uses web services standards-based tools such as WS-Security, XML-Encryption/Description, and XML-Signature to provide secure datapaths between services network members. These tools allow the client gateway 40 to leverage existent security protocols to ensure that authorized service consumers can participate in an end-to-end private business network. The security module 48 thus represents, in some embodiments, a central certificate and key management service for an enhanced over the core extranet service. The security module 48 provides security functions to other modules of the client gateway 40, and specifically to the policy enforcement module 46, the UDDI proxy module 51, the SOAP proxy module 52, the service handling module 53, and possibly both network interfaces 42, 44. These functions may include any or all of verification of signatures, encryption, decryption, signing, and exchanging of symmetric or asymmetric keys using protocols such as any of those that are known in the field of telecommunications security.

The SOAP proxy module 52 performs SOAP header handling for incoming and outgoing messages between clients and the services network. The SOAP proxy module 52 is a host that has two service addresses in two network interfaces: the access network 44 interface and the services network interface 42. As far as subscriber system clients of the client gateway 40 are concerned, all services advertised to the subscriber systems by the services network appear to be offered from the SOAP proxy module 52.

Messages from either of the two connected networks are addressed to the SOAP proxy module 52, which receives SOAP messages, performs such functions and modifications as header handling, and relays the messages to the appropriate processing facility, the UDDI proxy module 51 or the service handling module 53. Also, messages from the UDDI proxy module 51 and the service handling module 53 are sent to the SOAP proxy module 52. Messages received from the UDDI proxy module 51 or the service handling module 53 may be processed by the SOAP proxy module 52 to append Uniform Resource Identifier (URI) addressing information for instance. The SOAP proxy module 52 may also interact with the policy enforcement module 46 and the security module 48 to implement the network service policy on outgoing messages, and then sends each message on the appropriate interface. Policy enforcement, security, access control, auditing, and other functions associated with other modules of the client gateway 40 may thus be triggered by the SOAP proxy module 52 for each message.

To illustrate the operation of the SOAP proxy module 52, consider the following illustrative example: A service offered by one enterprise EB to another enterprise EA is proxied by the client gateway associated with EA to appear as if offered from a URI of the SOAP proxy module SPA of the client gateway. A service request from enterprise EA for a service offered by enterprise EB is sent to the SOAP proxy module SPA, which applies a set of functions and passes the message to the service handling module 53. Upon processing the service request, the service handling module 53 passes the message to the SOAP proxy module SPA, which appends the SOAP source and destination URIs SPA and SPB respectively, where SPB is the SOAP proxy module associated with the client gateway of enterprise EB. The request is then sent from SPA to SPB.

The SOAP proxy module SPB further manipulates the SOAP source and address URIs of the message to SPB and EB before forwarding the request to enterprise EB. In the reverse direction, similar modifications are applied to the response. The SOAP URI is manipulated in such a way to store both the service URI and the SOAP proxy of the gateway associated with that service.

The SOAP proxy module 52 classifies and splits incoming traffic into UDDI control traffic to be forwarded to the UDDI proxy module 51 and data traffic, illustratively XML traffic, to be forwarded to the service handling module 53. Traffic classification may involve deep packet inspection, for example.

Although not explicitly shown in FIG. 2 to avoid congestion, a traffic classifier of the SOAP proxy module 52 may be operatively coupled to either the services network interface 42 or to another interface that supports communications with a network controller, to provide for exchange of control and/or management traffic with a network controller. It should also be appreciated that the SOAP proxy module 52 may receive control and/or management traffic from a network controller.

The UDDI proxy module 51 acts as an access point into a UDDI central repository hosted by the services extranet network, for all UDDI Publish requests received from clients trying to publish new web services or subscribe to published changes of existent web services, and as a proxy module for all UDDI inquiry requests received from clients initiating ‘find service’ operations. Client access to network services is controlled, as disclosed herein, in accordance with network service policies. These policies may be enforced by the policy enforcement module 46 itself or in conjunction with the UDDI proxy module 51 to restrict the network services for which information is returned to a client system responsive to a find service or analogous operation.

The UDDI proxy module 51 expects ingress UDDI-based messages. All other messages that are not UDDI-framed may be discarded by the UDDI proxy module 51.

The UDDI proxy module 51 may cache UDDI entries locally at the client gateway level. This allows the UDDI proxy module 51 to perform local entry lookup and resolution when new UDDI inquiry requests are received. If a UDDI entry is locally found, then a UDDI response message is generated and sent back towards the client requesting the service.

If no UDDI entry is locally found, then the UDDI proxy module 51 may send a UDDI inquiry message to the network controller, for a global look-up into the UDDI global repository. Once the entry is resolved by the network controller, a UDDI response is sent back to the client gateway 40. The client gateway 40 may learn and store the UDDI information for further UDDI lookups.

Thus, the UDDI proxy module 51 may handle local and remote resolution of service requests.

The service handling module 53 receives service messages from the SOAP proxy module 52, handles the service messages, and sends service messages to the SOAP proxy module 52. One function of the service handling module 53 may be processing data traffic that is associated with a network service and being exchanged between the network service provider and consumer. In one embodiment, for example, service messages coming from the access network through the SOAP proxy module 52 are sent to the service handling module 53, which parses and modifies the messages to adapt them to the services network addressing and formatting rules. Formatting rules may be specified in a services network transform policy managed by the policy enforcement module 46, for example. The service handling module 53 then sends a corresponding service message to the client gateway associated with the network service provider through the SOAP proxy module 53 and across the services network.

The forwarding/routing module 54 performs forwarding/routing decisions towards destinations within the services network. Although this module 54 may have the ability to handle IP traffic, complete with DNS lookups when necessary, as well as networking at the XML level, other embodiments may provide only one, different, or possibly additional routing mechanisms.

When application layer routing is provided, the module 54 may provide content-based routing for the service handling module 53. The service handling module 53 may use the forwarding/routing module 54 to identify SOAP endpoints for a published message. An example embodiment of the SOAP proxy module 52, the service handling module 53, and the forwarding/routing module 54 provides mechanisms for publish-subscribe style networking. The present invention provides an alternate mechanism for supporting this functionality without requiring XML or other application routing capabilities at the forwarding/routing module 54.

An application routing layer of the forwarding/routing module 54 is optional, but may be suited to support notification and event distribution type services. In one embodiment, the application routing layer stores client subscriptions in a subscription database, and upon reception of an XML multicast document that matches a set of entries in the subscription database, uses these entries to identify the next SOAP endpoints that require the document and forwards the document to those endpoints through the SOAP proxy module 52. The subscription for documents and publication of documents may follow standardized mechanisms outlined in the WS-Notification and WS-Eventing recommendations.

The services network interface 42 provides at least a physical interface to a services network. The type and structure of the services network interface 42, and other operations that may be performed on communication traffic exchanged with a services network, will be services network-dependent. Many examples of such network interfaces will be apparent to those skilled in the art.

The data collector module 50 gathers real-time management and billing information, which may be processed locally and/or forwarded to a network controller or other component for further storage and processing.

Once all operations are executed successfully at the policy enforcement module 46 and a security enforcement point in the security module 48, secure client identity and message integrity can be guaranteed within a services network. At this point, the data collector module 50 can pull real-time information for various management and billing operations. Data may be collected for activities like transaction auditing, performance auditing, event monitoring, transactional end-to-end business activity monitoring (transaction completion/failure), activity logs, SLA monitoring, warnings and errors thresholds, alerts, etc. The data collector 50 may collect information at any of various stages in a datapath, such as after the security module 48 to count packets discarded per security policy, at the policy enforcement level to compile statistics on discard policies, etc.

A client gateway such as shown in FIG. 2 may be configured to allow a network service provider to offer its services into a services network as local services, to allow a network service consumer to use network services that are available in the services network, or both. An enterprise system served by the client gateway 40 may include both network service providers, in the form of enterprise application servers, and end user network service consumers.

When a subscriber system for which the client gateway 40 provides access to a services network has authenticated with the client gateway and wishes to offer its network services into a services network, control traffic received from the subscriber system, illustratively through a secure tunnel terminated at the access network interface 44 or as encrypted and signed messages, is processed as described above, and forwarded to the network controller in the services network.

The level of availability of a network service in the services network may be determined on the basis of an explicit access control rules specified by the network service provider or the network controller. A network service provider might request that a network service remain private, for use only by consumers within its own private enterprise system. Although not accessible to other members of a services network, restricting access to a private network service in a services network would allow a network service provider to take advantage of other functions of a services network, including policy enforcement and registry hosting for instance. Semi-private network services are also envisioned, in which a network service provider specifies particular services network members or groups to which a network service is to be made available. An unrestricted network service is accessible to all members of the services network 20 (FIG. 1), but may or may not also be offered to clients of the services network 30 or in the public network 34. Network services provided by subscriber systems associated with the services network 30 and the public network 34 may similarly be offered in the services network 20 through the gateways 26/32, 28.

Predetermined network service access controls may instead be configured at a network controller and applied to network services according to a type or class of a network service or a provider of the network service. All network services from a particular network service provider might have the same predetermined access controls that are established when the network service provider first registers with the services network, for example. Each network service provider may instead have a set of relationship categories, such as partners, suppliers, customers, and so on. In this case, privilege of access to each service may be given to one category, for example, and denied for another one. Another possible predetermined access control regime would make network services of a group of network service providers that have an existing business relationship available within only that group. Public network services imported into the services network from a public network as disclosed herein would generally be available to all clients of the services network.

In a central policy management model, any access controls associated with a network service are stored as a service context or policy by the network controller. These policies are downloaded to each client gateway by or through its policy enforcement module 46 and applied to traffic as described above. Subscriber system contexts may be downloaded to the policy enforcement module 46 at run time to support mobility of the mobile end user system 14 (FIG. 1) for instance.

Regardless of the particular access control scheme used to establish and manage access controls for network services, offered network services are made available within the services network in accordance with any access controls for each network service. This may be accomplished in several ways. As described above, control traffic is forwarded to and processed by a network controller in the services network. In this case, the network controller may publish information for the service in a registry which is accessible to client gateways in the services network. Each client gateway then controls access to registered network services by its clients in accordance with policies associated with the network services.

A services network is in no way limited to the above examples of network service access controls. Access controls need not necessarily be implemented at all within a services network. In some embodiments, all network services offered within a services network are automatically available to all members of the services network.

A network service provider might also modify policies of a network service, to change access controls for instance, in a substantially similar manner by exchanging control traffic with a network controller.

Once a subscriber system service message has been authenticated by the policy enforcement module 46 and security module 48, the subscriber system can also or instead access network services available in a services network through the client gateway 40. The particular network services that a subscriber system is able to access are controlled in accordance with policies managed by the policy enforcement module 46. A global registry of the services network might include registry entries for network services which are not available to every client, as specified in network service policies stored by a network controller and downloaded to the policy enforcement module 46. Only those network services to which a client of the client gateway 40 is allowed access are made available to the client.

Communication traffic that is subsequently exchanged between a subscriber system and a remote network service provider through the services network is processed substantially as described above. Traffic destined for the remote network service provider from the subscriber system is processed by the security module 48 based on security policies, modified in the SOAP proxy module 52 and handled differently based on message type in the service handling module 53, and finally routed to the remote network service provider, or actually to the gateway to which the remote network service provider is connected, by the forwarding/routing module 54 through the services network interface 42.

Substantially similar processing is applied to traffic associated with a network service provided by a subscriber system associated with the client gateway 40. Data traffic received from a remote network service customer through the services network interface 42 is processed, modified, and classified and handled as data traffic by the security module 48, the SOAP proxy module 52, and the service handling module 53. Received data traffic is then forwarded to the client by the access network interface 44.

Turning now to a public network gateway, such a gateway may be operatively coupled to a public network such as the Internet and a services network. In one embodiment, a public network gateway uses XML-standardized techniques for implementing and enforcing a secure XML datapath for network service traffic traversing multiple networks.

As described briefly above, a public network gateway provides a gateway between a private network, illustratively an extranet service, and a public network. A channel of communication between a public network gateway and a public network-based services network subscriber system may be created using any or all of IPsec, SSL, TLS, WS-Security, XML-Encryption, XML-Signature, WS-Trust, and WS-Federation, for example, to ensure that only authorized network service subscriber systems can participate in a services network while managing identity scopes with WS-Trust and WS-Federation.

Network services standards including UDDI, along with any or all of IPsec, SSL, TLS, WS-Security, XML-Signature, XML-Encryption, WS-Federation, and WS-Trust as noted above, may be implemented by a public service network gateway to interwork publishing network services between the two networks, to police service requests, and to enable legitimate network service connections to authorized network services between a public network and a protected services network.

According to one embodiment, a public network gateway is a SOAP-addressable point that cannot be circumvented during public network to services network communications. Security of communications between the public network gateway and systems in the public network may be provided, for example, via logical VPN tunnels through the public network.

In respect of network service management, a public network gateway may allow network service providers in a services network to publish internal network services to authorized subscriber systems over the Internet using secure communications, for instance. Network service providers in the services network may thus use a public network gateway to securely publish internal public network services to the UDDI registry of other service network members connecting to the services network through the public network gateway. In one embodiment, a public network gateway offers federated identity, access control, and policy enforcement functions, on all network layers, that have been set up in advance. Policies may be drawn from any or all of network service descriptions, subscriber system profiles established with and retrieved from a network controller, and services network policies. A public network gateway may also or instead allow subscriber systems of the services network to consume private or public network services available in a public network through other registries.

The operation of a public network gateway, which may be an Internet gateway or a gateway to a different type of public network, will now be described in further detail with reference to FIG. 3, which is a block diagram of an example public network gateway.

The public network gateway 55 includes a services network interface 56, a public network interface 57, a policy enforcement module 58 operatively coupled to the interfaces and to a memory 65, a security module 59 operatively coupled to the policy enforcement module, a SOAP proxy module 62 operatively coupled to the policy enforcement module, to the security module, and to the interfaces, a data collector module 60 operatively coupled to the SOAP proxy module and to the memory, a service handling module 63 operatively coupled to the policy enforcement module, to the security module, and to the SOAP proxy module, a UDDI proxy module 61 operatively coupled to the policy enforcement module, to the security module, to the SOAP proxy module, and to the public network interface 57, and a forwarding/routing module 64 operatively coupled to the SOAP proxy module, to the service handling module, and to the interfaces. As noted above for the client gateway 40 of FIG. 2, other interconnections between the components of FIG. 5 may be provided in some embodiments, but have not been explicitly shown to avoid congestion.

It will be apparent from a comparison of FIGS. 2 and 3 that a client gateway and a public network gateway may have substantially similar structures, and may perform substantially similar operations. Therefore, the following description of the public network gateway 55 concentrates on differences between the operation of the components of a public network gateway and similarly labelled components of a client gateway.

The public network interface 57 connects the public network gateway 55 to a public network. In some embodiments, the public network interface 57 is an IP interface, although the structure and operation of the public network interface 57 will be dependent upon the type of connection over which the public network gateway 55 communicates with the public network. In general, the public network interface 57 would include physical components that exchange communication signals with a communication medium, and hardware-, firmware-, and/or software-implemented components that generate and process the communication signals. Various implementations of such an interface will be or may become apparent to those skilled in the art.

For secure communications within the public network, the public network interface 57 may terminate secure VPN tunnels established through the public network. Other possible secure and non-secure communication protocols and schemes which may be used in a public network may be or become apparent to those skilled in the art.

The services network interface 56, the policy enforcement module 58, the security module 59, the memory 65, and the data collector module 60 may be similar in structure and operation to the corresponding components of a client gateway, described in detail above. It should be appreciated, however, that the functions of these components in a public network gateway bridge a services network and a public network.

In the public network gateway 55, the SOAP proxy module 62 has service addresses in the services network interface 56, like a client gateway, and in the public network interface 57. Otherwise, operation of the SOAP proxy module 62 may be substantially similar to that of the SOAP proxy module 52 of the client gateway 40 shown in FIG. 2. Whereas the SOAP proxy module of a client gateway exchanges messages between a services network and an access network, however, the SOAP proxy module 62 performs substantially similar functions between the services network and a public network such as the Internet.

The UDDI proxy module 61 presents a UDDI interface to the public network from the services network and to the central UDDI repository of the services network from the public network. The UDDI proxy module 61 may pass to a network controller in a services network all services publications from the public network UDDI registries that conform to the services network policy for offering services to services network subscriber systems. The UDDI proxy module 61 may modify the service endpoints of a service to force mediation of service interactions between public network services and service network services by the SOAP proxy module 62. The UDDI proxy module 61 may also present a customized list of network services available in the services network to each services network subscriber system connected to the services network over the public network. The UDDI proxy module 61 need not necessarily publish network services from the services network to public network registries. Publish and lookup functions of the UDDI proxy module 61 may be substantially as described above.

Another function of the UDDI proxy module 61 may be to prevent users in the public network that are not clients of the services network from finding network services in the services network.

The service handling module 63 operates in much the same manner as a client gateway service handling module. Service traffic need not necessarily be handled differently depending on whether that traffic is passing between a services network and an access network, as in the case of a client gateway, or between a services network and a public network.

Since the public network gateway 55 and the client gateway 40 (FIG. 2) have a presence in the same services network, the forwarding/routing module 64 and the services network interface 56 may be substantially similar to the corresponding components of the client gateway 40 (FIG. 2).

Security modules at communicating gateways provide communication security over a services network. Secure communications may thus be provided between client gateways, between public network gateways, or between a client gateway and a public network gateway.

A public network gateway such as shown in FIG. 3 may be configured to allow network service provider clients of a services network to access network services available in a services network through a public network such as the Internet, to allow network service providers in a public network to offer their services into a private services network, or both. Communication traffic is also transferred between the services network and the public network by the public network gateway.

A network service provider controls availability of its network services, as described above, by establishing access control policies when publishing the network service to the services network global registry, for instance. Public network gateways restrict access to network services from the services network to clients of the services network that may connect from the public network. The public network gateway denies access to network services from the services network to non-member hosts on the public network.

Public network gateways are also responsible for publishing network services provided by public network clients of the services network into the services network registry, so as to provide for inter-network service offerings and inter-registry publishing from a public network into a services network. In this case, public network services provided by network service providers in a public network are made available in the services network by exchanging control traffic with the network controller of the services network. Network service provider-specific policies may be of particular significance for network services provided by network service providers in a public network. Network services that are imported from a public network are public network services and thus would normally be made accessible to all network service consumer clients of the services network. However, it is contemplated that policies may be specified for public network services in some embodiments.

Publishing of public network services into a services network by a public network gateway may be handled by the public network gateway automatically, by identifying network services in public registries that are provided by clients of the services network, or responsive to explicit service publication requests received from public network-based clients of the services network. Publication in response to requests may be accomplished by a public network gateway substantially as described above for a client gateway.

Although public network services that are provided by network service providers located in a public network are normally accessible to any network service consumer that can communicate with the network service provider, the services network is a private network. The public network gateway allows clients connecting from the public network to consume services offered within the services network, but it does not allow public servers that are not clients of the services network to consume services within the services network. Once a client from the public network is authenticated with a public network gateway and authorized for access to the services network, the client has access to public network services and network services offered to the client by the client's partners in the services network. Authentication with a public network gateway effectively authenticates a network service consumer with the services network, and no additional authentication with a network service provider client is necessary.

It should be noted that the policy enforcement module of a public network gateway may enforce any or all of services network policies, network service policies, and client policies. Some of these policies may be centrally managed by and downloaded from a network controller. The policy enforcement module 58 enforces restrictions on public network service consumer access to network services offered in the services network by clients or by other networks. Only clients of the services network may access network services from the services network through a public network gateway.

As described above, a services network is a private, protected network. In order to maintain a level of control over the public network services which are accessible in the services network, a public network gateway may also be configured to authenticate network service providers in a public network before their network services are made available in the services network.

Auditing of network service-related transactions by a public network gateway may be useful for billing consumers for use of public network services, whether the consumers are services network clients or located in a public network. Although services network clients may already have an established business relationship, there would not typically be any existing relationship between a network service consumer client of the services network and a network service provider in the public network. Authentication of a public network-based provider and auditing of any subsequent transactions with the services network might thus be particularly important where a public service provided by a consumer in a public network is used by a services network client. Authentication of the provider ensures proper identification of the network service provider, and auditing allows tracking and billing of that provider's activities. As noted above, audit records may also or instead be used by a gateway, a network controller, or another system for other purposes than billing.

When an internal network service provided by a subscriber system that accesses a services network through a client gateway or a public network gateway is being used by a subscriber system that accesses the services network through another client gateway or a public network gateway, the gateways exchange network services traffic. In the case of a subscriber system using an external network service that is provided in a different services network, a client gateway or public network gateway forwards data traffic toward the services network gateway listed in the services network registry for the external network service. The underlying mechanism for a client gateway or public network to exchange traffic with a services network gateway can be based on any tunnelling protocols supported in a core network.

Like a client gateway and a public network gateway, a services network gateway classifies and splits incoming data traffic from an external services gateway into control traffic to be forwarded to its local network controller, or to a designated network controller where multiple network controllers exist in the local services network, and data traffic to be forwarded towards a destination. It also forwards outgoing control data, including information about the presence of local network services to be flooded or advertised to the next peer services network or border gateway, illustratively in the form of advertisement messages containing lists of valid network services and their descriptions. In some embodiments, the outgoing control data is generated by the local designated network controller and is sent down to the services network gateway for publication to peer services network gateways.

Since client identity and access control functions are implemented at client gateways and public network gateways in a services network, these functions need not be provided by services network gateways in some embodiments. Network services data security, on the other hand, may be provided at services network gateways in a substantially similar manner as at client gateways, using WS-Security, XML-Encryption and XML-Signature, for example. Services network gateways may also implement enforcement of policies that have been established using the local network controllers.

Audit and monitoring records compiled by services network gateways may be locally stored and processed by each services network gateway, sent to network controllers or other systems in one or more services networks for processing, or both. Network controllers may use such records to check regulatory and policy compliance, for example.

The operation of a services network gateway will become apparent from the following detailed description of FIG. 4, which is a block diagram of an example services network gateway.

The services network gateway 70 includes a local services network interface 72, a services network gateway interface 74, a policy enforcement module 76 operatively coupled to the interfaces and to a memory 77, a security module 78 operatively coupled to the policy enforcement module, a SOAP proxy module 82 operatively coupled to the policy enforcement module, to the security module, and to the interfaces, a data collector module 80 operatively coupled to the SOAP proxy module and to the memory, a service handling module 83 operatively coupled to the policy enforcement module, to the security module, and to the SOAP proxy module, a network controller (NC) proxy module 81 operatively coupled to the policy enforcement module, to the security module, to the SOAP proxy module, and to the services network gateway interface 74, and a routing module 84 operatively coupled to the SOAP proxy module, to the service handling module, and to the interfaces. As noted above for the client gateway 40 of FIG. 2 and the public network gateway 55 of FIG. 3, other interconnections between the components of FIG. 4 may be provided in some embodiments, but have not been explicitly shown to avoid congestion.

Since a services network gateway and a client gateway (FIG. 2) may have substantially similar structures and perform substantially similar operations, the following description of the services network gateway 70 relates primarily to differences between these gateways.

The services network gateway interface 74 connects the services network gateway 70 to an external services network, possibly through another services network gateway. The structure and operation of the services network gateway interface 74 will be dependent upon the type of connection over which the services network gateway 70 communicates with the other services network. The services network gateway interface 74 includes hardware-, firmware-, and/or software-implemented components for generating and processing communication signals exchanged with another services network gateway or services network through a communication medium. Various implementations of such an interface will be apparent to those skilled in the art. In one embodiment, the interface 74 terminates a secure communication tunnel for a connection between the services network gateway 70 and another services network gateway. Other possible communication protocols and schemes that may be used for communications between services networks will be or may become apparent to those skilled in the art.

The local services network interface 72, the policy enforcement module 76, the security module 78, the memory 77, and the data collector module 80 may be similar in structure and operation to the corresponding components of a client gateway, described in detail above. It should be appreciated, however, that the functions of these components in a services network gateway provide for interworking between two services networks instead of between a service network and an access network.

Thus, the policy enforcement module 76 enforces services network policy and provides a proxy service function for network services as configured by the network services members in their subscriber system profiles and advertised in their services' descriptions to the local services network. Policy enforcement for external services may be handled by gateways in the external services network, and accordingly policies for external network services might not necessarily be enforced by the services network gateway 70.

Privacy and integrity of communication traffic associated with network services may also be managed by the policy enforcement module 76. The policy enforcement module 76 may interact with the security module 78 to verify a message digital signature for example.

Other functions of the policy enforcement module 76, such as SLA monitoring and message transformations, will be apparent from the foregoing description of the substantially similar client gateway policy enforcement module 46 of FIG. 2. It should be appreciated, however, that whereas a policy enforcement module of a client gateway may perform client authentication and authorization functions in conjunction with its security module, these functions might not be provided at a services network gateway, since a services network gateway might not directly manage client access to a services network.

On the other hand, each services network gateway may identify itself to another services network gateway and authorize traffic received from another services network gateway based on a service policy specification. However, this policy may be defined by means of cooperation between the borders of two administration domains. Such a policy may specify which gateways in a services network, client gateways for example, have access to communicate to which external inter-services network gateways, the access security technology for the point-to-point pipes between these gateways (IPSec, IP VPNS, etc), the level of access to public/private services between different administrative domains, etc.

The security module 78 implements and enforces on traffic security standards, specified in the local services network policy, to guarantee the security of communications between services networks and in the local and external services networks. In some embodiments, the security module 78 ensures traffic security by using web services standards such as WS-Security, XML-Encryption/Decryption, and XML-Signature to provide secure datapaths. In general, the security module 78 provides security functions to other modules of the services network gateway 70.

The data collector module 80 operates substantially as described above, to gather real-time information for use in management and billing, for instance.

The SOAP proxy module 82, like the corresponding module 52 of the client gateway 40 (FIG. 2), performs SOAP header handling for incoming and outgoing messages between the services networks. The SOAP proxy module 82 is a host that has two service addresses in two network interfaces: the services network gateway interface 74 and the local services network interface 72. Subscriber systems of the local services network connecting to external network services through the services network gateway 70 will perceive all external services as appearing to be offered from the SOAP proxy module 82.

Messages from either of the two connected services networks are addressed to the SOAP proxy module 82, which receives SOAP messages, performs such functions and modifications as header handling, and relays the messages to the appropriate processing facility, the NC proxy module 81 or the services handling module 83. Messages from the NC proxy module 81 and the service handling module 83 are also sent to the SOAP proxy module 82. Messages received from the NC proxy module 81 or the service handling module 83 may be processed by the SOAP proxy module 82 to append URI addressing information for instance. The SOAP proxy module 82 also interacts with the policy enforcement module 76 and the security module 78 to implement the network service policy on messages and then sends the messages on the appropriate interface. Policy enforcement, security, access control, auditing, and other functions associated with other modules of the services network gateway 70 may thus be triggered by the SOAP proxy module 82 for each message.

Operation of the SOAP proxy module 82 may be substantially similar to that of the SOAP proxy module 52 of the client gateway 40 shown in FIG. 2, which has been described in detail above by way of illustrative example. As will be apparent, however, whereas the SOAP proxy module of a client gateway exchanges messages between a services network and an access network, the SOAP proxy module 82 performs substantially similar functions between services networks. The address and formatting requirements between services networks may also be different than those between an access network and a services network. Thus, the SOAP proxy module 82 applies message transformations and addressing conversions in accordance with the formats and address spaces used in the different services networks.

The SOAP proxy module 82 classifies and splits incoming traffic into control traffic and data traffic. The control traffic is forwarded to the NC proxy module 81 and data traffic, illustratively XML traffic, is forwarded to the service handling module 83. In a client gateway, control traffic is normally exchanged with a network controller, whereas in a services network gateway, control traffic may be exchanged both within and outside of a local services network, to enable external publication of local network services.

A traffic classifier of the SOAP proxy module 82 may be operatively coupled to either the local services network interface 72 or to another interface that supports communications with a local network controller, to provide for exchange of control and/or management traffic with a network controller. In FIG. 4, one possible form of a connection for exchanging control information with an external services network is shown through the NC proxy module 81, which is operatively coupled to the services network gateway interface 74. It should also be appreciated that the SOAP proxy module 82 may receive control and/or management traffic from a network controller in a local services network, an external services network, or both.

According to one embodiment, the NC proxy module 81 has the following characteristics:

It presents an interface, a UDDI interface for instance, to the central UDDI repository of the local designated network controller.

When traffic coming from an external services network enters a services gateway, it passes to the local designated network controller all network services publications from the external services network registries that conform to the services network policy for offering to the services network clients.

It also passes to the external services network, through the services network gateway interface 74, control traffic, which is generated by the local designated network controller in some embodiments, for advertising local network services into the external services network.

The advertisement control function itself may be implemented in the designated network controller, in which case this function involves exchanging control traffic between two designated network controllers of two services networks, by updating each other's registries with the corresponding external services.

Registry entries in a services network global registry for network services of a remote or external services network are marked as external. For all external services, the registry may store other information like addresses of services network exit points, i.e., the services network addresses of services network gateways through which these external network services are accessible.

The designated network controller in a services network also preferably stores in its registries the next hop towards a network service destination, which is the first hop after data traffic exits the local administrative domain. This next hop might be the ingress services network gateway which is the service delivery point for the external service. This information is downloaded to the routing module 84 of the services network gateway 70.

The policy enforcement module 76 may control external publication of local network services, publication of network services from an external services network into the local services network, or both, as part of the dedicated service policy specification for services network to services network communication.

Advertisement messages may be created by the local designated network controller for announcing internal network services outside of the local services network. An advertisement control function of a network controller may generate advertisement messages responsive to different network service events, such as at network service initialization, to provide an initial list of existing local network services to the external services network, or at runtime, new network service creation, network service update for changes in location for instance, or network service deletion. Event notifications may be provided to the services network gateway 70 by its local designated network controller.

A designated network controller with which a services network gateway communicates may incorporate a network services advertisement module or function for handling inter-services network publication of network services. In one possible implementation in which multiple network controllers are provided in a single services network, network controller software is identical for all network controllers, but network services advertisement software supporting inter-network functionality is not operational unless a network controller is configured as the designated network controller in a services network. Configuration of a network controller as the designated network controller for a services network may be accomplished, for example, through a network management system.

As described below with reference to FIG. 5, the service type of each available network service may be indicated in a services network registry of a services network. A service type indication represents one mechanism by which the network service advertisement module may distinguish internal and external network services, such that only internal network services are advertised to an external services network. As a services network does not itself host providers of registered external network services, external network services might not be advertised to other services networks. Other techniques for distinguishing internal and external network services, based on network service provider location information for example, are also contemplated.

The NC proxy module 81 may modify the service endpoints of a local network service to force mediation of service interactions between local network services and clients of the external services network, and between local clients and external network services provided in the external services network, by the SOAP proxy module 82.

The message handling capabilities of the NC proxy module 81 will be dependent upon the types of messages used for communications between designated network controllers. In one embodiment, UDDI-based messages are used between designated network controllers. Proprietary control messages are also contemplated. All messages that are not UDDI-framed, in the proprietary format, or in some other expected format, may be discarded by the NC proxy module 81.

The structure and operation of a service handling module may be substantially the same whether that service handling module is implemented in a client gateway, in a public network gateway, or in a services network gateway, as is the case for the service handling module 83. In one embodiment, service messages coming from the local services network through the SOAP proxy module 82 and associated with an external network service are sent to the service handling module 83, which parses and modifies the messages to adapt them to external services network addressing and formatting rules. The service handling module 83 then sends a corresponding service message to the external services network, or the services network gateway associated with the external services network, in which the network service is provided, through the SOAP proxy module 83 and the services network gateway interface 74.

The routing module 84 and the local services network interface 72 in the services network gateway 70 may be substantially similar to the corresponding components of a client gateway 40 (FIG. 2) in the local services network.

Security modules at communicating gateways provide communication security over a services network. Secure communications may thus be provided between any combination of client, services network, and public network gateways.

The local services network interface 72 provides at least a physical interface to the local services network, and is compatible with services network interfaces provided at other gateways in a services network. The type and structure of the local services network interface 72, and other operations which may be performed on communication traffic which is exchanged with other gateways and a network controller in the local services network, will be services network-dependent, and many examples of such network interfaces will be apparent to those skilled in the art.

A services network gateway such as shown in FIG. 4 may be configured to allow network service consumer clients of a services network to access network services available in another services network, to allow network service providers in a services network to offer their services into another services network, or both. Communication traffic is also transferred between services networks by the services network gateway.

Control over availability of network services may be maintained by a network service provider by establishing access control policies when publishing the network service to the services network global registry, for example. These access control policies specify the extent to which a network service is to be made available, within a services network and/or externally in one or more other services networks. Other parameters may be specified in network service policies, and these may also be transferred between services networks for storage in a policies registry for instance and enforcement by client gateways and/or public network gateways, as described above, when clients of a services network make use of external network services.

A services network gateway may automatically publish network services into an external services network by identifying network services in a local services network registry that are provided by clients of the services network, for instance.

In a central policy management model, access controls associated with network services are stored as service contexts or policies by a local network controller, and downloaded to a services network gateway for enforcement, so as to control whether a local network service is advertised externally.

When accessing an external service, client authentication and authorization are performed only once inside the local services network, at the ingress client gateway or public network gateway. Once an external service appears as accessible through the local network controller, then traffic is forwarded towards its destination in the local services network, which is the services gateway specified in the services registry. From there, data traffic is distributed to the next previously learned hop, which in some embodiments is the ingress services gateway into the external services network. No client authentication is required while entering the second administrative domain. The client thus authenticates with the network only once, no matter whether the network is one services network or the network is composed by multiple services networks linked together through services network gateways.

With reference to FIG. 4, traffic destined from a local network service provider to an external network service consumer client is processed by the policy enforcement module 76, classified as data traffic by the SOAP proxy module 82, and processed by the SOAP proxy module in collaboration with the security module 78. A resultant service message is handled by the service handling module 83, which may modify the message, the security module 78 performs security processing to apply security such as XML-level security on the modified message, and the message is routed by the routing module 84 through the services network gateway interface 74 to the network service consumer client, possibly through a services network gateway in the external services network to which the network service consumer client is connected. The external services network gateway then handles forwarding of the traffic to the network service consumer client through a client gateway of the external services network.

Data traffic destined for a local network service provider is processed in a substantially similar manner by the services network gateway 70. Data traffic received from an external network service consumer client of the external services network through the services network gateway interface 72 is processed by the policy enforcement module 76, classified as data traffic by the SOAP proxy module 82, and security processing is performed by the security module 78. Received data traffic destined for a local services network client is also processed by the services handling module 83, which modifies the message for adaptation to the local services network. The message is then passed to the SOAP proxy module 82, which appends local services network addressing information that is routable in the local services network. The message is then forwarded to the local services network client through the local services network by the local services network interface 72.

Communication traffic between a provider client in the external services network and a consumer client in the local services network is also handled substantially as described above.

It should be noted that the policy enforcement module of a services network gateway may enforce any or all of services network policies, service policies, and client policies. Some of these policies may be centrally managed by and downloaded from a network controller. The policy enforcement module restricts external availability of local network services.

Auditing of network service-related transactions by a services network gateway may be useful for billing consumers for use of network services, whether the consumers are clients of the local services network or an external services network. Although clients of the same services network may already have an established business relationship, there might not be an existing relationship between all clients of local and remote services networks. Auditing of inter-services network transactions might thus be particularly important where network services are offered between different services networks, to allow tracking and billing of network service activities. As noted above, audit records may also or instead be used by a gateway, a network controller, or another system for other purposes than billing.

Various functions of a services network may be managed by a network controller, as noted above. FIG. 5 is a block diagram of an example network controller. The network controller 90 includes a management system interface 92, a gateway interface 94, and a memory 96, which are operatively coupled to managers 100, 104, 106, 109. The components of the network controller 90 may be provided in either a centralized architecture or a distributed and possibly centrally manageable architecture.

The management system interface 92 provides an interface to a management system, such as a Network Management System (NMS) for instance, which implements a central framework for configuration and management of a services network platform. The structure and operation of the management system interface 92 will be dependent upon the type of connection over which the network controller 90 communicates with its management system. In some embodiments, a network controller communicates with a management system through a managed communication network. Separate NMS management and control channels are also common. Those skilled in the art will be familiar with examples of both types of management system interfaces, including interfaces using XML and interfaces that provide access to Management Information Bases (MIBs) for instance.

The gateway interface 94 represents an interface through which the network controller 90 communicates with each gateway in a services network. Although shown as a single component in FIG. 5, the gateway interface 94 may include respective interfaces, and possibly different types of interfaces, for communication with different gateways. As described above, control traffic may be exchanged between a client gateway and a network controller through the services network, using a services network interface, or some other type of interface. The gateway interface 94 of FIG. 5 might therefore include an interface that is compatible with the services network interfaces 42 (FIG. 2), 56 (FIG. 3), 72 (FIG. 4), or another type of interface, provided at client, services network, and public network gateways.

Like the interfaces described above with reference to FIGS. 2 to 4, the management system interface 92 and the gateway interface 94 include hardware-, firmware-, and/or software-implemented components that generate and process the communication signals exchanged with a communication medium.

The memory 96 includes one or more memory devices for storing information. The information stored in the memory 96 may include information such as subscriber system profiles and policies, security information, and access lists and access level groups per subscriber system and per network service for use by components of the network controller 90, as well as registry information for access and use by other equipment in a services network. It should be appreciated, however, that the memory 96 may include both local and remote memory devices. Whereas network controller software might be stored locally, registries might be distributed and stored in remote memory devices that are accessible to both the network controller 90 and client, services network, and public network gateways to which network service consumers are connected.

Some or all of the managers 100, 104, 106, 109, and internal functions or components of the interfaces 92, 94, may be implemented as software. Software implementing these managers and functions might also be stored in the memory 96.

The policy manager 100 provides comprehensive policy provisioning and definition, and security policy management capabilities. Policy management is centralized by the policy manager 100, although the policies may be stored in a distributed manner throughout the services network. Policy components, such as the policy manager 100 and a registry in the memory 96 in which policy information is stored for instance, may be distributed. Also, policies information is downloaded into the policy enforcement modules in gateways, as described above.

A centralized approach to policy management for network services allows a single set of policies to be managed by delegated administrators, in the services network provider's infrastructure. The policy manager 100 may be configured to automatically download or push policy information to gateways, to transmit policy information responsive to requests from gateways, or to support both push and pull policy information transfer mechanisms.

According to one possible implementation, the policy manager 100 manages network service policies using a network service policies registry. The network services policies registry is a collection of network service policies that establish access controls for all network services offered within a services network. The policy registries may be part of a data registry that is used to store other information such as service description and subscriber system profiles.

Each individual network service policy may specify privacy parameters, such as the authentication information that must be presented in a message, whether a message has to be signed and/or encrypted, which parts of a message are to be signed and/or encrypted, and how messages or parts thereof are to be signed and/or encrypted. These functions may be provided by implementing existent web services standards, such as WS-Security, WS-Policy, WS-PolicyAttachment, WS-PolicyAssertions and WS-SecurityPolicy. There may also be rules indicating the levels of access to specific network services, illustratively private, semi-private/group, and public at a services network or virtual extranet level, for example. There may also be SLA agreements and QoS requirements for the end-to-end services, and lists and details regarding business partners involved in specific business transactions.

For any new network services providers or consumers joining a services network, consumer profiles and policies are preferably created at registration time. As described above, a network service provider publishes its network services within a services network by sending control traffic to a network controller through a gateway. A network controller may also manage public network services, which may be consumed through a public network, as specified by public network service policies. In general, policies received from gateways through the gateway interface 94 or from a management system through the management system interface 92 can be centrally managed by the policy manager 100, but physically distributed within a virtual extranet provided by a services network.

Where a network service provider or consumer has its own service policies at the time of joining a services network, the policy manager 100 may allow the external service policies to be integrated into the services network's global policy registry. All management data at the services network level may thereby be integrated with other data from enterprise management systems in order to create a globally-managed virtual extranet service, for instance.

The policy manager 100 may also manage user authorizations and security profiles within the services network rather than with specific network service applications as is the typical scenario within an enterprise, and manages the authorization of the authenticated client endpoint. A network service consumer in the enterprise space, for example, connects to the services network through a client gateway or a public network gateway and does a single-sign-on with the services network. The centralization of access control information into one registry entity hosted by the network controller avoids the problem of sharing identity information and access control policies between enterprise systems. Instead, this data is stored within the services network.

Legacy authorization systems may also be accommodated by the policy manager 100, illustratively by offering the data necessary for translating existent proprietary session cookies into SAML assertions and real-world identities that can then be mapped to other identity repositories.

The policy manager 100 may specify message header and message payload transformations to be applied to data traffic by gateways in a services network. In some embodiments, transformations are made between XML-based web service messages and other formats of messages in accordance with information, illustratively XML schemas, stored in a registry.

The security manager 104 manages the security of communications through a services network. In one embodiment, the security manager 104 uses established network services and XML standards to guarantee secure communications. For example, a secure datapath created over the services network core may use WS-Security and XML-Encryption, as described above. Whereas gateways actually establish secure connections through a services network, the security manager 104 provides a central certificate and key management service for the services network. Security information is downloaded to gateways for use in establishing secure communications with other gateways through the services network. Like the policy manager 100, the security manager 104 may be configured to automatically download or push security information to gateways, to transmit security information responsive to requests from gateways at runtime when gateways require security information for network services transactions, or to support both push and pull transfer mechanisms.

The registries manager 106 manages and sanitizes network service registries, illustratively industry standard registries such as UDDI, with advanced meta-data capabilities for network service location and management. The services network provider can store registry entries for available network services based on classification categories and branding they define, for example. Network services may be organized in a registry according to permitted levels of access, which may include private, public, semi-private group, and/or others, for instance. As described above, some network services may be published privately to specific partners, while other network services are published publicly to the whole services network.

A network services registry managed by the registries manager 106 is a collection of network services from all network service providers connected directly or indirectly to a services network. For a new network service provider or consumer that does not have any registries capability at the time when it joins the services network, the registries manager 106 offers a full collection of network services, descriptions, locations, ownerships, and public Application Programming Interfaces (APIs) that allow a network service to be advertised and consumed. A network service provider may instead have its own registries at the time when it joins the services network, in which case the registries manager 106 may allow the provider's network services to be published into the services network's global network service registry.

Other meta-data registries may also be available for storing network services information for purposes other than basic network service location and management. These may include registries for use by other network controller components to manage service aspects such as timeouts, XML schemas to be applied, service contracts, QoS parameters, and subscription and addressing information. Additional registries may store collections of data obtained as a result of storing billing information, SLA monitoring information, transactional end-to-end business activity monitoring information, activity logs and performance auditing information, and exception alerts, and also client profiles which include billing, preferences, partners, etc., for instance. User credentials, general policies, and security policies may be stored in the registries as well.

In some embodiments, subscriber systems of a services network have real-time console-access and management tools for real-time monitoring and querying of all registry information, in accordance with their service policy.

The system manager 109 receives audit records captured by gateways to provide centralized control, monitoring, and auditing of transactions, events, warnings, and alerts, for instance, and may also manage delivery of comprehensive contracts and SLAs. Transaction priorities are preferably implemented based on their criticality. Other possible functions of the system manager 109 include reporting on transaction completions/failures and management of SLA contracts.

As described above, services network gateways may implement and enforce a secure datapath, illustratively an XML datapath, and a control path for network services traffic between different network providers implementing the same extranet-based service. When two network providers implement the same extranet service model, there is a possibility to enrich each services network with network services located in the other services network.

Inter-services network communications through services network gateways enable network service consumer subscriber systems of each services network to take advantage of an enlarged set of network services. Network service provider subscriber systems of the services network can also make their network services visible and accessible in multiple different services networks having respective administrative domains with respective sets of subscriber systems.

A services network gateway in a services network provides an edge device function, used for communication with another services network, possibly through a peer services network gateway in the other services network. Peer services network gateways may be operationally connected one-to-one in a point-to-point fashion, by means of static provisioning or dynamic discovery. The one-to-one connection might be a direct link, as shown in FIG. 1, or an indirect link, such as a network link which traverses another communication network.

Network services data traffic is forwarded by a services network gateway, at wire-speed, on a secure datapath towards another services network. Services network gateways also exchange network services control traffic for the purpose of advertising network services of one services network into another services network. In one embodiment, each services network gateway shares network service presence information with one or more peer services network gateways in other services networks.

Services network gateways interact with network controllers to export network services to other services network and to import network services from other services networks. When multiple network controllers are available within a single services network extranet, the services network gateway might interact directly only with one designated network controller. A designated network controller may be selected and then enforced by means of provisioning at the service network gateway interface or box level, for instance. A designated network controller could be the same as an ordinary network controller, but configured as a designated network controller through a command line interface (CLI) of an operator terminal through the management system interface 92, for example.

Where network services registries are maintained in multiple network controllers within one services network, the network controllers may communicate among themselves for exchanging control information about the services contained in each of their registries and about these services' local storage.

Therefore, a network controller may store in its registries information, provided to it by gateways and possibly other network controllers, associated with internal network services provided by its own subscriber systems and information associated with external network services available from network service providers in other services networks. The designated network controller in a multiple-controller services network may receive network service-related information from other network controllers, services network gateways, or both.

Network services may be published to registries with a distinctive service type, internal versus external. A designated network controller receiving network services updates coming from a services network gateway may publish them automatically as external, whereas new network services registered through client gateways could be published as internal. Services registered through public network gateways are public services, and thus could be regarded as either internal or external.

Further details on gateways and network controllers can be found, for example, in U.S. patent applications Ser. No. 11/105,732 entitled “NETWORK SERVICES INFRASTRUCTURE SYSTEMS AND METHODS”, Ser. No. 11/105,601 entitled “PUBLIC AND PRIVATE NETWORK SERVICE MANAGEMENT SYSTEMS AND METHODS”, and Ser. No. 11/105,821 entitled “SYSTEMS AND METHODS FOR MANAGING NETWORK SERVICES BETWEEN PRIVATE NETWORKS”, all filed on Apr. 14, 2005. The entire contents of each of these patent applications is incorporated herein by reference.

In accordance with an aspect of the present invention, support for publication subscription services is provided to allow such services to run efficiently in a web services enabled extranet. A publication subscription service may be used to implement content routing-based applications, including any or all of e-mail, Really Simple Syndication (RSS), document synchronization, event monitoring, application messaging, Radio Frequency Identification (RFID) messaging, etc. Although these technologies often use XML protocols such as XQuery or XPath, a services network may internally implement this functionality using WS-Notification and/or derivatives of that protocol, for example, to give the appearance of content routing (such as XML routing) without the expense and complexity of deploying XML routers.

Gateways in a services network might be capable of receiving and executing XPath/XQuery functions for arbitrary content routing. A subscriber of a publication subscription service might request to receive all content that includes the subscriber's name and/or address, or all documents with a company name and any phone number. Each gateway would have an address, illustratively an IP address, for the interface through which the publication subscription service is provided, and would check messages received from the provider gateway against the content routing rules prior to network layer routing to a subscriber system or in some cases to another gateway.

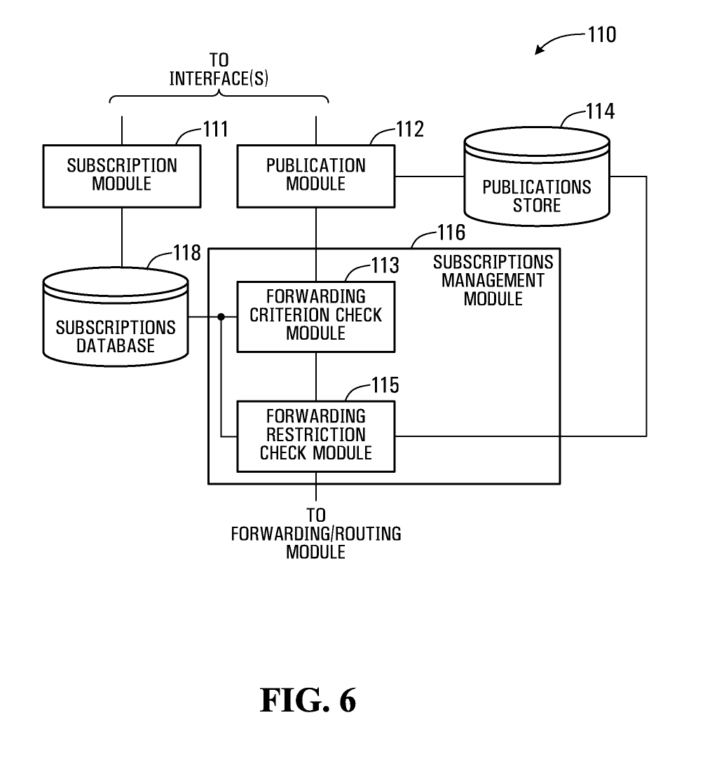

These and other features of embodiments of the invention are described below with reference to FIGS. 6 to 8.

FIG. 6 is a block diagram of a publication subscription service apparatus. The apparatus 110 may be provided, for example, at least in each client gateway of a services network, or possibly in any or all client, services network, and public network gateways in a services network. It should therefore be appreciated that the apparatus 110 may interact with further components, the specific types of which may vary between implementations in different gateway devices.

The apparatus 110 includes a subscription module 111, a subscriptions database 118 operatively coupled to the subscription module, and a subscriptions management module 116 operatively coupled to the subscriptions database, to a publication module 112, and to a publications store 114, which is also operatively coupled to the publication module. The subscriptions management module 116 includes a forwarding criterion check module 113 operatively coupled to the publication module 112 and to the subscriptions database 118, and a forwarding restriction check module 115 operatively coupled to the forwarding criterion check module, to the publications store 114, and to the subscriptions database.

As noted above for the preceding drawings, the apparatus 110 is illustrative of one embodiment of the invention, and other embodiments may include further, fewer, or different components interconnected in a similar or different manner than shown.

Many of the components of the apparatus 110 may be implemented in hardware, software, and/or firmware, and thus are described herein primarily in terms of their function. A person skilled in the art would be enabled to implement embodiments of the invention in any of various ways, as software for execution by a processing element for instance, based on the functional descriptions.

The publications store 114 and the subscriptions database 118, however, represent storage areas that may be provided in one or more memory devices. Solid-state and/or other types of memory devices may be suitable for this purpose.

When a services network subscriber becomes aware of a publication subscription service, the subscriber may wish to subscribe to that service through the client gateway or public network gateway that provides access to the services network for the subscriber. This subscription process may be supported in any of several ways.

Subscriptions messages are handled in the apparatus 110 by the subscription module 111. According to one embodiment, all aspects of a publication subscription service, including subscription, are distributed between gateways in a services network. In this case, the subscription module 111 receives subscription messages from services network subscriber systems to register those subscriber systems for various publication events. Publication events may include “publish” messages received and stored in a client gateway prior to the arrival of subscription messages and/or new publish messages received after a subscription has been created, for instance.

Where the apparatus 110 is implemented as a service handling module in a client gateway, for example, the subscription module 111 may handle subscription messages for any services network subscriber systems that are connected to that gateway and also satisfy any conditions for use of the service, as established by the provider of the service when the service is first published into the network controller of the services network. Subscription messages might be received through an access network interface, detected by a SOAP proxy module, and passed to the subscription module 111 substantially as described above. Subscription messages may be handled by other gateways in a similar manner, although in some embodiments only client gateways and public network gateways perform subscription-related operations. If a services network subscriber has not yet been authenticated by its client gateway or public network gateway, processing of a subscription message might be delayed pending authentication of the subscriber system. Authentication can be performed in an inbound direction when the authentication data is included in the subscription message, or in an outbound direction prior to the first subscription.

Subscription messages may include service information such as an identifier of the publication subscription service, its provider, and/or its location, an identifier of the subscriber system, a subscription ID, and one or more events of interest to the subscription. Events of interest for each subscription may specify, or be used to generate, forwarding criteria in accordance with which published content, generally referred to herein as electronic publications, are to be forwarded to a subscriber system. A subscriber system might wish to receive all documents made available to the publication subscription service by a particular publishing entity, documents that list the name of a subscriber or company, etc. These events of interest may be included in the subscription request, or possibly established and/or revised after a services network subscriber has subscribed to the service. In one embodiment, events of interest are specified as, or translated into, XPath and/or XQuery expressions.

Received subscription messages could possibly be processed and granted or denied locally, at a client gateway, which may then advise a network controller and/or a provider of the service of the new subscription. According to another subscription scheme, the subscription module 111 forwards received subscription messages to a network controller or to a gateway through which the provider system accesses the services network. A subscriber system and a provider system may access a services network through different client, services network, or public network gateways, for example.

In this scenario, the network controller or provider system makes a decision as to whether a requesting subscriber system is to be allowed to subscribe to the publication subscription service. A response to the subscription request is then returned to the gateway of the requesting subscriber system to indicate whether the services network subscriber system has been added as a subscriber of the publication subscription service.

Subscriber system information is stored in the subscriptions database 118 by the subscription module 111 when subscription operations are complete. This information might be stored in the subscriptions database 118 only when an incoming subscription is accepted. In the event of a denial of authentication for the incoming subscription or refusal of an incoming subscription for some other reason, subscriber system information could be stored in the subscriptions database 118 or possibly another memory such as a gateway memory store, for request and denial tracking purposes for instance.

Changes to a publication subscription service subscriptions list may be communicated not only to a client gateway associated with a new subscriber system, as in the above example, but also to other gateways in a services network. WS-Notification, for example, may allow gateways to register with a gateway to which the provider system is connected, for notifications of subscriber changes. Each registered gateway is then notified when a new subscription is added, and/or when a subscription is removed from a publication subscription service. A complete subscription list might be distributed to all registered gateways. Each gateway might then identify subscriptions associated with its own subscriber systems and physically store information associated with those subscriber systems in its subscriptions database 118.

More selective update/notifications procedures are also contemplated. A gateway might be updated/notified, for example, only when subscription list changes relate to subscriber systems that access a services network through that gateway.

Subscription notifications from a gateway to a publication subscription service provider could also or instead be selective. As described in further detail below, a publication service provider system transmits electronic publications to gateways, and dissemination of those electronic publications to subscriber systems is handled at the gateway level, based on one or more forwarding criteria. Forwarding criteria may be maintained as a forwarding table built up from subscriptions, for example, listing the subscriptions and/or the corresponding subscriber system gateways to which electronic publications are to be forwarded. These criteria may also include electronic publication conditions to enable routing of electronic publications based on source, keywords, other content, etc.

A service provider system that is configured to forward electronic publications to gateways need not necessarily be aware of specific subscriber systems that subscribe to its service. A client gateway might advise a network controller or service provider system only when any one of its subscriber systems first subscribes to the service for possible publication events, since the gateway should then be sent electronic publications as they are published, or when a last subscription of any of its subscriber systems is cancelled and the gateway is thus no longer interested in certain publications associated with the service.

In many implementations, however, it is expected that records/profiles of all subscribers including their authentication credentials, at the subscriber system level, will be kept by a service provider system.

Dissemination of electronic publications is handled by the publication module 112 and the subscriptions management module 116. Although only client gateways and public network gateways might perform subscription-related operations in some embodiment, any or all of client gateways, services network gateways, and public network gateways might handle electronic publications for a publication subscription service.

The publication module 112 receives electronic publications that are available to a publication subscription service by a publishing entity. The publishing entity may, but need not necessarily, be the service provider system. A service provider system may accept publications from other entities, for example, and make those publications available in its publication subscription service. In a gateway device implementation of the apparatus 110, an electronic publication may be received through an access network interface, a services network interface, or a public network interface, and forwarded to the publication module 112 by a SOAP proxy module of the gateway device.

The action taken by the publication module 112 may be dependent upon how an electronic publication is received. An electronic publication that is being submitted to a service provider system by a publishing entity connected to a gateway device, for example, might be forwarded to the service provider system and/or to a network controller. Any forwarding restrictions that may have been established by the publishing entity for the electronic publication, if received with the electronic publication, are also transmitted to the service provider system and/or to the network controller. Based on these forwarding restrictions, the service provider system then decides whether to make the publication available to certain subscribers. Where the forwarding restrictions exclude all subscribers to the service, for example, the electronic publication might not be accepted by the service provider system.

Once an electronic publication is accepted by a service provider system, the service provider system then forwards the publication to all gateways in a services network, or at least to those gateways through which subscriber systems that subscribe to the publication subscription service access the services network. This process may be implemented, for example, using an event notification scheme such as WS-Notification to set up publish/subscribe relationships between the gateways whereby a gateway advises other gateways of changes in its publication store 114, although other techniques may also or instead be provided for this purpose. In this type of implementation, a provider of a publication subscription service might transmit a new publication to its access gateway, which then disseminates the publication to other gateways.

An accepted electronic publication is stored in the publications store 114 by the publication module 112. A stored electronic publication may be maintained in the publications store 114 at least until it has been forwarded to one or more subscriber systems as described below, and possibly longer to support dissemination of earlier publications to new subscribers. Forwarding restrictions may also be received and stored in the publication store 114.

The subscriptions management module 116 enables forwarding of electronic publications to subscriber systems that subscribe to the publication subscription service. In a subscription message, or after the subscription process has been completed, one or more events of interest may be specified by a subscriber system and used as or used to generate forwarding criteria, as described above. The forwarding criterion check module 113 determines whether an electronic publication received by the publication module 112 satisfies any electronic publication forwarding criteria for each subscription.

Forwarding criteria may be stored in the subscriptions database 118 or another store as a forwarding table that is created out of subscriptions in the subscriptions database and accessed by the forwarding criterion check module 113. For example, multiple subscriptions could be compacted into a single entry in the forwarding table as one forwarding criterion. Subscriptions that share a common event of interest, to receive all electronic publications from a particular source, for instance, could be consolidated in this manner as a list of subscriptions associated with a forwarding table entry that identifies that source. It should be noted that the forwarding criterion check module 113 might apply exact matching rules, regular expression matching, or both, during forwarding criterion checking.

In the example apparatus 110, the forwarding criterion check module 113 receives the electronic publication from the publication module 112. However, it should be appreciated that the forwarding criterion check module 113 may also or instead access the electronic publication in the publications store 114. The forwarding criterion check module 113 might access the publications store 114 to disseminate to a new subscriber electronic publications that were previously received and stored, for instance.

According to another aspect of the invention, a publishing entity may limit the dissemination of an electronic publication by establishing one or more forwarding restrictions for the electronic publication. The subscriptions management module 116, and in particular the forwarding restriction check module 115, determines whether a subscription for which an electronic publication matches a forwarding criterion, also satisfies any forwarding restrictions for the electronic publication, to thereby determine whether the electronic publication is to be forwarded to the subscriber system. A subscriber from one company's enterprise system might request forwarding of any documents published by another company. The other company, however, might well wish to prevent this, and establish appropriate forwarding restrictions for its electronic publications.

Forwarding restrictions may exclude particular subscribers, all subscribers in certain enterprises or at certain locations, etc. The forwarding restriction check module 115 may therefore access subscription information in the subscriptions database 118 to determine whether a subscriber is excluded from receiving an electronic publication by its forwarding restrictions.

It should be appreciated that forwarding restrictions need not necessarily be specified in detail by a publishing entity. Private and semi-private designations for example, as described above for network services, represent one form of forwarding restriction that would not entail specifying every subscriber or gateway to which a publication may or may not be forwarded. Other logical groups may be defined in a services network and used to specify forwarding restrictions. Subscriber-, group-, gateway-, and services network-level forwarding restrictions are contemplated. Forwarding restrictions based on other subscriber or services network conditions are also contemplated, and may be or become apparent to those skilled in the art.

Forwarding restrictions may be stored in the publication store 114, as noted above, or separately. The forwarding restriction check module 115 may thus access the forwarding restrictions in the publication store 114, and determine whether an electronic publication should be forwarded to each subscriber system.

Where an electronic publication satisfies a forwarding criterion for a subscription, and the subscription satisfies any forwarding restrictions for the electronic publication, the electronic publication is forwarded to the corresponding subscriber system. References herein to forwarding restrictions, and similarly forwarding criteria, being satisfied are intended to convey the notion that conditions for forwarding an electronic publication have been satisfied, and should be interpreted accordingly. These conditions may relate to an electronic publication itself, a subscriber, or both.

In the apparatus 110, the subscriptions management module 116 outputs the electronic publication to a routing/forwarding module for forwarding to one or more subscriber systems. This forwarding may be directly to a subscriber system in the case of a client gateway or a public network gateway. The subscriptions management module 116 thereby enables another component, namely a component of the gateway, to forward publications to subscriber systems. In other embodiments, the forwarding function may be performed by the same component or module that makes forwarding decisions.

A gateway may also forward an electronic publication to other gateways, which then independently determine whether the electronic publication is to be forwarded to other subscriber systems. At least the gateway through which an electronic publication is made available in a services network, for example, may forward the electronic publication to another gateway in a services network. A client gateway connected to the service provider system may process an electronic publication to determine whether that publication is to be forwarded to any of its own subscriber systems, and also forward the publication to other gateways in a services network. The publication may be forwarded to all gateways of a services network, or only to those gateways through which subscriber systems that subscribe to the publication subscription service access the services network.

Inter-gateway forwarding may be subject to forwarding restrictions, and accordingly may be handled by the subscriptions management module 116. Although electronic publications need not necessarily satisfy subscriber system forwarding criteria to be forwarded between gateways, the forwarding restriction check module 115 may be active for inter-gateway forwarding.

It should be appreciated that not every electronic publication received by the publication module 112 would necessarily have forwarding restrictions. The subscriptions management module 116 at a gateway might therefore enable forwarding of an unrestricted electronic publication to any subscriber system connected to the gateway, while also supporting restricted dissemination of an electronic publication for which a forwarding restriction has been established.

Forwarding restrictions may be provided by a publishing entity with each electronic publication. Forwarding restrictions for a publication subscription service, however, could potentially be centrally managed by a network controller, for instance. In this type of implementation, the network controller might receive and aggregate forwarding restrictions on a per-service basis and distribute an aggregation of the forwarding restrictions to gateways. With reference to FIG. 5, these functions could be handled by the policy manager 100, for example. The subscriptions management module 116 at each gateway then extracts forwarding restrictions from the aggregation.

Gateway-based electronic publication processing and inter-gateway forwarding of electronic publications as described above provide for a distributed implementation of a publication subscription service. Instead of loading a single server with all publication dissemination tasks, as in conventional publish/subscribe implementations, these tasks are distributed to multiple devices. A distributed service may be faster and more scalable than a single-server implementation. Receipt of electronic publications at multiple gateway devices, or more generally access points into a communication system, causes independent determinations to be made as to whether the electronic publication is to be forwarded to any subscriber systems at those gateway devices or access points.

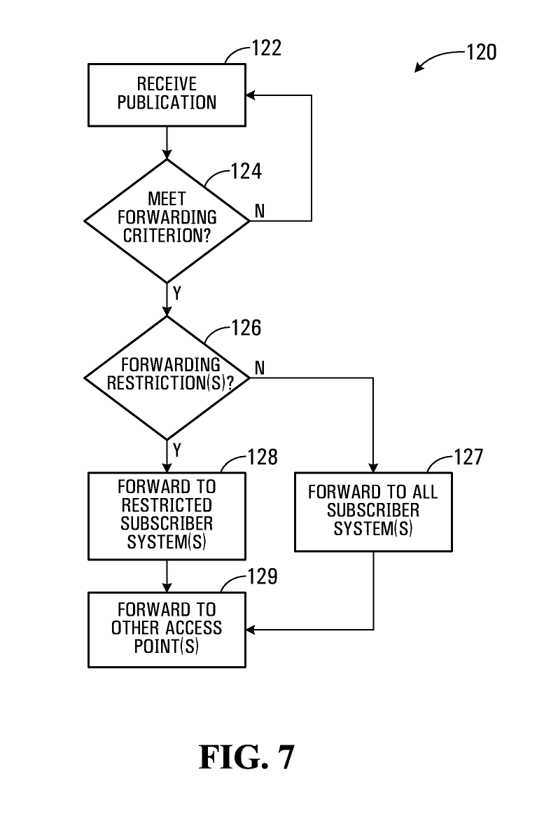

Embodiments of the invention have been described above primarily in the context of an apparatus. FIG. 7 is a block diagram of a publication subscription service method.

The method 120 involves receiving at 122 an electronic publication that has been made available to a publication subscription service by a publishing entity in a communication system. At 124, a determination is made as to whether the electronic publication satisfies a forwarding criterion, and thus is to be forwarded to a subscriber system. This determination might be independently made at multiple gateway devices or access points, for example, and for each subscriber system connected to such a gateway device or access point.

If the electronic publication does not satisfy a forwarding criterion for a subscription, such as a subscription associated with any of the subscriber systems connected to a gateway device at which the method 120 is being executed, no further operations need necessarily be performed for that electronic publication. The method 120 may, however, start again when a new electronic publication is received at 122.

A forwarding restriction check is performed at 126 if the electronic publication meets a forwarding criterion for a subscription. An unrestricted electronic publication is forwarded to all subscriber systems for which the electronic publication meets a forwarding criterion, as shown at 127. For a restricted electronic publication, forwarding at 128 is limited to one or more subscriber systems that satisfy any forwarding restrictions associated with the electronic publication.

The electronic publication may also be forwarded to other gateway devices or access points, as shown at 129, in a distributed publication subscription service. Although illustrated in FIG. 7 as following subscriber system forwarding operations at 127, 128, inter-gateway forwarding operations might not depend on forwarding criteria or restrictions, as described above. The method 120 might revert to 129 instead of to 122 in the event that a received publication does not satisfy a forwarding criterion at 124.

It should be appreciated that the method 120 represents an illustrative embodiment of the invention. Other embodiments may involve further, fewer, or different operations performed in a similar or different order than shown. Some variations of the method 120 may be evident from the foregoing descriptions of FIGS. 1 to 6, and further variations may be or become apparent to those skilled in the art.

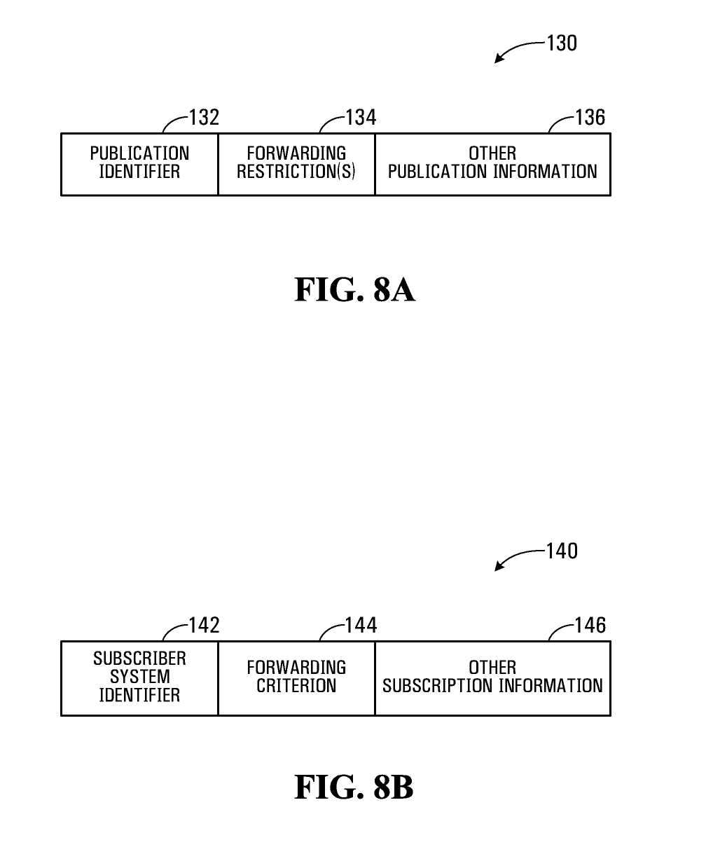

Aspects of the invention may also be embodied in data structures that may be stored in the publications store 114 and the subscriptions database 118 (FIG. 6), for example. FIGS. 8A and 8B are block diagrams of illustrative publication and subscription data structures, respectively.

The publication data structure 130 includes an identifier 132 of an electronic publication, and may be a file or document name or a number that is unique in the publication subscription service, for instance. An indication of one or more forwarding restrictions established for the electronic publication is provided at 134. The forwarding restrictions, as described in detail above, limit dissemination of the electronic publication among subscriber systems that subscribe to a publication subscription service. These restrictions may be specified in any of various forms, such as permitted or excluded subscriber system identifiers, permitted or excluded enterprise systems, permitted or excluded locations, subscriptions received within a certain period of time such as within the last week only, or subscriptions that meet certain criteria. Where a network controller in a services network manages subscriber systems by groups, the forwarding restrictions might specify particular groups to which the electronic publication may or may not be forwarded. Other options for specifying forwarding restrictions may be or become apparent to those skilled in the art.

A publication data structure may also include other information relating to an electronic publication, as shown at 136.

FIG. 8B shows an example of a subscription data structure 140. The subscription data structure 140 includes an identifier 142 such as an address of a subscriber system as shown, although a subscription identifier could also or instead be provided at 142. An indication 144 of a forwarding criterion is provided at 144. The forwarding criterion is used to determine whether an electronic publication is to be forwarded to a subscriber system associated with the subscription. A personal and/or company name, an address, and a keyword are all examples of forwarding criteria that could be specified at 144.

At 146, additional subscription information may be stored. This additional information might include, for example, any or all of the location of a subscriber system associated with the subscription, the group(s) to which the subscriber system belongs, the service(s) to which the subscriber system subscribes, etc. Location information, and other information stored at 146, could be used to determine whether the subscription satisfies forwarding restrictions for an electronic publication, for instance.

The data structures 130, 140 may be stored in the same data store, such as in service records, or in respective separate memory areas or devices. In one embodiment, the data structure 140 is used for entries stored in a forwarding table.

Publish/subscribe capabilities as disclosed herein may enable a services network to be used effectively for such applications as sensor networks, RFID, building automation, messaging (e-mail, RSS, Instant Messaging (IM), chat), content routing and delivery, and remote device monitoring. Many of these possible applications represent new approaches and markets, because a publish/subscribe enabled public network does not currently exist.

In accordance with embodiments of the invention, arbitrary content routing, i.e., the appearance of XML based content routing, is provided in a communication network for delivering web services, illustratively a web services extranet. Various types of gateways in a communication system, including any or all of client, mobile, public network, and border gateways, may receive and process XPath and/or XQuery expressions, and using WS-Notification for instance, set up publish/subscribe relationships with all other gateways in the system. A network controller could provide such functions as aggregation and dissemination of rules for applying policies to isolate logical groupings of services network subscriber systems with respect to arbitrary content routing requests.

A network-enabled publish/subscribe service may be capable of performing filtering and aggregation that scales beyond what current single-server publish/subscribe systems can deliver. Another potential advantage is that “XML-like” routing in a services extranet can be provided without the expense and complexity of deploying XML routers or devices capable of XML routing techniques. Content routing can be performed in addition to classic network routing/switching with policy and security necessary for isolation of enterprise systems in some embodiments.

What has been described is merely illustrative of the application of principles of embodiments of the invention. Other arrangements and methods can be implemented by those skilled in the art without departing from the scope of the present invention.

For example, the present invention is in no way limited to the divisions of functions shown in FIGS. 1 to 6. Embodiments of the invention may be implemented with fewer, further, or different components interconnected in a similar or different order than shown. Variations of the method shown in FIG. 7 and the data structures shown in FIGS. 8A and 8B are similarly possible. In FIG. 7, for instance, an electronic publication may be forwarded to subscriber systems on the same interfaces that were previously learned when subscriptions were received. In other words, a forwarding table may also contain an outgoing port for the subscriber system and/or gateway associated with each subscription.

It should also be appreciated that electronic publication forwarding decisions need not necessarily be based only on forwarding restrictions. As described in detail above, forwarding criteria may specify additional conditions for forwarding electronic publications to subscriber systems. Other types of information could also or instead be considered during the forwarding decision process. It may be desirable for a publishing entity to allow the subscriptions management module at its gateway to override a forwarding restriction for an electronic publication under certain circumstances such as a state of emergency, for example. Publishing entities could be advised if this function is part of normal subscriptions management module operations. An override function could instead be supported by a subscriptions management module but ultimately controlled by a publishing entity and/or service provider as part of a profile or other configuration information for instance. Forwarding decisions are thus based on forwarding restrictions, but need not necessarily be based only on forwarding restrictions, in some embodiments.

We claim:

1. An apparatus comprising:
a publication module operable to receive an electronic publication made available to a publication subscription service by a publishing entity in a communication system; and
a subscriptions management module operatively coupled to the publication module and operable to determine, based on a forwarding restriction established for the electronic publication by the publishing entity, whether the electronic publication is to be forwarded to a subscriber system that is associated with a subscription to the publication subscription service.

2. The apparatus of claim 1, wherein the publication module is operable to receive a plurality of electronic publications including the electronic publication and at least one electronic publication for which no forwarding restriction has been established, the subscriptions management module being operable to enable forwarding of the at least one electronic publication to a subscriber system associated with any subscription to the publication subscription service, and to determine, based on a forwarding restriction established for each other electronic publication of the plurality of electronic publications, whether each other electronic publication is to be forwarded to a subscriber system that is associated with a subscription.

3. The apparatus of claim 1, wherein the communication system comprises a private services network accessible by a plurality of subscriber systems including the subscriber system.

4. The apparatus of claim 3, wherein the subscriptions management module is further operable to receive the forwarding restriction from at least one of: the publishing entity and a network controller of the private services network.

5. The apparatus of claim 4, wherein the subscriptions management module is further operable to receive from the network controller an aggregation of a plurality of forwarding restrictions including the forwarding restriction, and to extract each forwarding restriction of the plurality of forwarding restrictions from the aggregation.

6. The apparatus of claim 1, wherein the subscriptions management module is further operable to generate, based on subscription information received from the subscriber system, an electronic publication forwarding criterion, and to forward the electronic publication to the subscriber system where the electronic publication satisfies the electronic publication forwarding criterion and it is determined based on the forwarding restriction that the electronic publication is to be forwarded to the subscriber system.

7. The apparatus of claim 6, wherein the subscriptions management module comprises:
a forwarding criterion check module operable to determine whether the electronic publication satisfies the electronic publication forwarding criterion; and
a forwarding restriction check module operatively coupled to the forwarding criterion check module and operable to determine, where the electronic publication satisfies the electronic publication forwarding criterion, whether a subscription associated with the subscriber system satisfies the forwarding restriction.

8. The apparatus of claim 6, wherein the electronic publication comprises an eXtensible Markup Language (XML) document, and wherein the forwarding criterion comprises at least one of: an XPath expression or an XQuery expression.

9. The apparatus of claim 1, implemented in a gateway device that is operable to provide access to a private services network by the publishing entity.

10. The apparatus of claim 1, wherein the subscriptions management module is operable to determine whether the electronic publication is to be forwarded to a subscriber system by restricting forwarding of the electronic publication to only subscriber systems that are associated with respective subscriptions that satisfy the forwarding restriction.

11. A private services network comprising:
a plurality of gateway devices, each comprising an apparatus as claimed in claim 1, operable to provide access to the private services network by one or more private services network subscriber systems, the private services network subscriber systems comprising the publishing entity and the subscriber system,
wherein the subscriptions management module of the gateway device that provides access to the private services network by the publishing entity is further operable to establish a respective publication subscription service relationship with each other gateway device of the plurality of gateway devices, and wherein the subscriptions management module of each gateway device of the plurality of gateway devices independently determines, based on the forwarding restriction, whether the electronic publication is to be forwarded to a publication subscription service subscriber system, for which the gateway device provides access to the services network, that is associated with a subscription.

12. A method comprising:
receiving an electronic publication made available to a publication subscription service by a publishing entity in a communication system;
determining a forwarding restriction established for the electronic publication by the publishing entity; and
determining, based on the determined forwarding restriction, whether the electronic publication is to be forwarded to a subscriber system that is associated with a subscription to the publication subscription service.

13. The method of claim 12, wherein receiving comprises receiving a plurality of electronic publications including the electronic publication and at least one electronic publication for which no forwarding restriction has been established, further comprising:
forwarding the at least one electronic publication to a subscriber system associated with any subscription to the publication subscription service,
wherein determining whether the electronic publication is be forwarded to a subscriber system comprises determining, based on a forwarding restriction established for each other electronic publication of the plurality of electronic publications, whether each other electronic publication is to be forwarded to a subscriber system that is associated with a subscription.

14. The method of claim 12, further comprising:
receiving subscription information from the subscriber system;
generating, based on the received subscription information, an electronic publication forwarding criterion; and
forwarding the electronic publication to the subscriber system where the electronic publication satisfies the electronic publication forwarding criterion and it is determined based on the forwarding restriction that the electronic publication is to be forwarded to the subscriber system.

15. The method of claim 12, further comprising:
establishing a publication subscription service relationship between gateway devices that provide access to a private services network by one or more private services network subscriber systems, the private services network subscriber systems comprising the publishing entity and the subscriber system; and
forwarding the electronic publication from a gateway device that provides access to the private services network by the publishing entity to each other gateway device of the plurality of gateway devices,
wherein each gateway device of the plurality of gateway devices independently determines the forwarding restriction and determines whether the electronic publication is to be forwarded to a publication subscription service subscriber system, for which the gateway device provides access to the private services network, that is associated with a subscription.

16. A machine-readable medium storing instructions which when executed perform the method of claim 12.

17. A communication system comprising:
a first gateway device comprising a publication module operable to receive an electronic publication made available to a publication subscription service of the communication system, and a subscriptions management module operatively coupled to the publication module and operable to provide access to the publication subscription service by at least one subscriber system of the communication system, to determine whether the electronic publication is to be forwarded to a subscriber system of the at least one subscriber system, and to forward the electronic publication to at least one other gateway device; and
a second gateway device comprising a second publication module operable to receive the electronic publication from the first gateway device, and a second subscriptions management module operatively coupled to the second publication module and operable to provide access to the publication subscription service by at least one further subscriber system of the communication system, and to determine, independently of a determination made by the subscriptions management module of the first gateway device, whether the electronic publication is to be forwarded to a subscriber system of the at least one further subscriber system.

18. The system of claim 17, implemented in a private services network, the first and second gateway devices providing access to the private services network by respective groups of one or more private services network subscriber systems, the private services network subscriber systems comprising a publishing entity by which the electronic publication is made available and at least one subscriber system associated with a respective subscription to the publication subscription service,
wherein the subscriptions management module of the one of the first and second gateway devices that provides access to the private services network by the publishing entity is further operable to establish a publication subscription service relationship the other of the first and second gateway devices.

19. The system of claim 18, wherein the first and second gateway devices comprise gateways of at least one of the following types: a client gateway for providing access to the private services network through a secure access connection or network, a public network gateway for providing access to the private services network through a public network, a mobile gateway for providing access to the private services network by a mobile subscriber system, and a services network gateway for providing access to the private services network through another private services network.

20. A method comprising:
receiving an electronic publication made available to a publication subscription service of a communication system;
determining, at an access point of a plurality of access points through which respective groups of communication system subscriber systems access the communication system, whether the electronic publication is to be forwarded to a subscriber system of the group of subscriber systems that access the communication system through the access point;
forwarding the electronic publication to a further access point of the plurality of access points; and
determining at the further access point, independently of a determination made at the access point, whether the electronic publication is to be forwarded to a subscriber system of the group of subscriber systems that access the communication system through the further access point.

21. A machine-readable medium storing a data structure, the data structure comprising:
an identifier of an electronic publication made available by a publishing entity in a communication system to a publication subscription service; and
an indication of a forwarding restriction, established for the electronic publication by the publishing entity, based upon which a determination is to be made as to whether the electronic publication is to be forwarded to a subscriber system associated with a subscription to the publication subscription service.

22. The medium of claim 21, wherein the data structure further comprises:
an identifier of a subscriber system that is associated with a subscription to the publication subscription service; and
an indication of a forwarding criterion, the forwarding criterion defining a criterion to be satisfied by electronic publications that are to be forwarded to the subscriber system.
